(19) United States
(12) Patent Application Publication
(10) Pub. No.: US 2025/0085201 A1
(43) Pub. Date: Mar. 13, 2025

(54) SUBSTITUTED QUADRUPOLAR FLUORESCENT DYES FOR LIVE CELL IMAGING

(71) Applicant: Northwestern University, Evanston, IL (US)

(72) Inventors: Yuanning Feng, Evanston, IL (US); James Fraser Stoddart, Evanston, IL (US)

(21) Appl. No.: 18/828,883

(22) Filed: Sep. 9, 2024

Related U.S. Application Data
(60) Provisional application No. 63/581,275, filed on Sep. 7, 2023.

(51) Int. Cl. G01N 1/30; C09K 11/06

(52) U.S. Cl. CPC G01N 1/30; C09K 11/06; G01N 2001/302

(57) ABSTRACT

Described herein are methods, compositions, and cyclophanes for live cell imaging. The method comprises irradiating a cell in contact with a composition for live cell imaging and detecting an emission signal, wherein the composition for live cell imaging comprises a cyclophane having an alternating cyclic arrangement of two A subunits and two B subunits.

### CROSS-REFERENCE TO RELATED APPLICATIONS

This application is the national stage entry of U.S. Application Ser. No. 63/581,275, filed Sep. 7, 2023. The contents of which are incorporated by reference in its entirety.

### GOVERNMENT FUNDING STATEMENT

This invention was made with government support under grant number DMR2003739 awarded by the National Science Foundation. The government has certain rights in the invention.

### FIELD OF THE INVENTION

The disclosed technology is generally directed to compositions, methods, and kits for live cell imaging. More particularly the technology is directed to substituted quadrupolar fluorescent dyes.

### BACKGROUND OF THE INVENTION

Push-pull fluorescent dyes, which feature electron donating (D) substituents connected to electron accepting (A) substituents have been investigated¹⁻⁹ as environmentally sensitive fluorophores. The design and synthesis of fluorescent organic compounds containing push-pull chromophores have emerged as an active area of research over the past two decades as a result of their potential applications in the fields of photovoltaics,¹⁰⁻¹² non-linear optics,¹³⁻¹⁴ organic light emitting diodes¹⁵⁻¹⁸ (OLEDs), fluorescent sensors,^{19,20} and bioimaging.²¹⁻²⁴ Although quadrupolar chromophores,²⁵⁻⁴² which contain symmetrical structures, have no permanent dipole moment, experimental data^{25-38,43-48} point to the existence of polar excited states. Time-resolved fluorescence anisotropy measurements suggest that the initially delocalized excitation can be localized on the picosecond time-scale over one branch of the chromophore, leading to the formation of a polar state.

These electron densities can be modulated⁴⁹ by the introduction of a variety of substituents, i.e., electron-donating groups (EDGs) and/or electron-withdrawing groups (EWGs). In addition, heterocyclic units have been introduced^{25,45,50-57} into π-conjugated systems to modulate their photophysical and electrochemical properties. Extended bipyridinium-based cyclophanes⁵⁸⁻⁶⁰ (ExⁿBox⁴⁺) and their π-conjugated analogues⁶¹⁻⁶³ have been investigated extensively by us in the past. Studies on these box-like fluorescent tetracationic cyclophanes were conducted for biological imaging⁶³⁻⁷⁰ carried out on tetracationic and octacationic fluorescent cyclophanes,⁶³ cages⁶⁵⁻⁶⁶ and catenanes.⁶⁷⁻⁷⁰

### BRIEF SUMMARY OF THE INVENTION

Disclosed herein are methods, compositions, and kits for live cell imaging. The method comprising a cell in contact with a composition for live cell imaging and detecting an emission signal, and the composition for the same. wherein the composition for live cell imaging comprises a cyclophane having an alternating cyclic arrangement of two quadrupolar subunits and two bridging subunits, wherein the quadrupolar subunit has a formula of

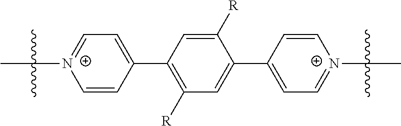

and wherein R is an electron-donating group (EDG). In some embodiments, R are independently selected alkoxy groups. In some embodiments, the R are methoxy groups. In some embodiments, the composition for live cell imaging is non-cytotoxic at a concentration between 1-50 μM. In some embodiments, the method includes detecting radiation emitted from the cyclophane internalized within the cell. In some embodiments, the cells used are cancer cells.

An aspect of the invention includes the composition for live cell imaging comprises the previously described cyclophane, wherein the composition for live cell imaging emits a detectible signal when the composition for live cell imaging comprises between 1-10 μM of the cyclophane.

Another aspect of the invention includes a kit for live cell imaging, the kit comprising a first container containing the composition for live cell imaging according and a second container containing a cell.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIG. 1 (a) Graphical representations of the solid-state structure of the tetracationic cyclophane 9⁴⁺. Plan view (Left) of a stick representation with the corresponding semitransparent space-filling image superimposed upon it, showing distances and bond angles associated with the cyclophane's geometry. Side-on views (Middle and Right) of stick representations of 9⁴⁺, illustrating the distances and dihedral angles associated with the cyclophane's geometry. (b) Plan views (Left) of the solid-state superstructures of 9⁴⁺, showing the centroid-to-centroid distance and side-on views (Middle and Right), illustrating the plane-to-plane distance between adjacent dimethoxyphenylene rings. Hydrogen atoms, solvents and counterions are omitted for the sake of clarity.

FIG. 2 Overlay of the UV/Vis absorption spectra of the quadrupolar fluorescent dyes. (a) Normalized peaks for 1, 2, 3, 4 and 5 recorded in THF at 298 K. (b) Normalized peaks for 6 and 9·4PF₆ recorded in MeCN at 298 K. Peaks have been normalized based on the maximum absorption bands.

FIG. 3 Overlay of the fluorescence emission spectra of the quadrupolar fluorescent dyes. (a) Normalized peaks for 1, 2, 3, 4 and 5 recorded in THF. (b) Normalized peaks for 6 and 9·4PF₆ recorded in MeCN. Peaks have been normalized based on the maximum emission bands.

FIG. 4 Transient absorption spectra of the tetracationic cyclophane. (a) Combined fs- and nsTA spectra of 9·4PF₆ in MeCN at 298 K following a ˜100 fs, 414 nm (1 J/pulse) excitation. (b) Multiple-wavelength fits and time constants from the fsTA for 9·4PF₆ excited at 414 nm. (c) Evolution-associated spectra for an A→B→C→D→ground state sequential decay model. (d) State diagram showing kinetic competition between intramolecular charge transfer (ICT), relaxation (Relax), internal conversion (IC), radiative recombination (RR), charge recombination to singlet ground and triplet excited states (CR—S and CR-T, respectively), and intersystem crossing (ISC).

FIG. 5 State diagrams for dyes (a) 1-4 and 6 in MeCN, (b) 5 in MeCN and PhMe and (c) 7·2PF₆ and 9·4PF₆ in MeCN on the same energy scale showing competitive decay pathways: Solvation and structural/vibrational relaxation (Relax), non-radiative internal conversion (IC), radiative decay (fluorescence, R), Intramolecular charge transfer (ICT), Radiative Recombination (RR), charge recombination to singlet ground and triplet excited states (CR—S and CR-T, respectively), and intersystem crossing (ISC).

FIG. 6 (a) Cell growth curves resulting from imaging every 4 h for 64 h under standard (37° C., 5% CO₂) culture conditions. (b) Percentage growth after 64 h of incubations. Cells were seeded onto multiwell plates for 24 h then treated with the dye at a range of concentrations from 0.1-50 μM and imaged for 64 h.

FIG. 7 Cells treated with 9·4Cl at 50 μM (a/b/c) and 10 μM (d/e/f) concentrations, respectively, for 24 h and imaged using laser scanning confocal microscopy. (a/d) Images of cells exhibiting green emission at 500-650 nm (λₑₓ=405 nm). (b/e) Transmitted light images. (c/f) Merged images showing the composite of emission and transmission light images. Arrows pointed at dye 9·4Cl taken up by living cells and concentrated in intracellular compartments.

FIG. 8 Illustrates Scheme 1 synthesis of the alkoxy-substituted quadrupolar fluorescent dyes, namely 1-6, 7·2PF₆, 8·2PF₆ and 9·4PF₆.

FIG. 9 Normalized fluorescence emission spectra of 5 in a variety of solvents at 298 K. Insert: distribution of maximum emission wavelengths (λₑₘ).

FIG. 10 Live cell confocal microscopy images of MCF-7 breast cancer cells in cell culture media incubated with 9·4Cl at 1 μM for 24 h, under normal (a/b/c) and higher (d/e/f) laser power conditions. (a/d) Images of cells exhibiting green emission at 500-650 nm (λₑₓ=405 nm). (b/e) Transmitted light images. (c/f) Merged images showing the composite of emission and transmission light images. Arrows pointed at dye 9·4Cl taken up by living cells and concentrated in intracellular compartments. Brightness maxima is adjusted at 50 to show the comparison.

### DETAILED DESCRIPTION OF THE INVENTION

Described herein are methods, compositions, and kits for live cell imaging. The methods comprise irradiating a cell in contact with a composition for live cell imaging. Moreover, the composition for live cell imaging comprises a cyclophane. These compositions are non-cytotoxic and can be delivered easily into living cells. These methods, compositions, and kits contain bright and persistent chromophores which are able to be detected at low concentrations. The kits for live cell imaging comprise a first container containing the composition for live cell imaging and a second container containing the cell. As a result, these methods, compositions, and kits have ideal properties for use in live cell imaging.

The methods, compositions, and kits comprise a cyclophane having a chromophore incorporated therein. The cyclophanes disclosed herein are rigid and box-like as a result of the incorporation of a molecular strut into the cyclophane. Without wishing to be bound to theory, it is believed that the rigid, box-like structure prevents intercalation of the cyclophane into DNA or inhibits any other interactions that may be potentially cytotoxic to a host cell being imaged.

As demonstrated in the examples that follow, the compositions are capable of being taking up by cells and resist cell death under live-imaging conditions. Cyclophanes may be prepared and their properties can be modified by changing their building units or introducing different functional groups into the cyclophanes by means of covalent bonds. Rigid, box-like cyclophanes may be less likely to intercalate into or interact electrostatically with DNA on account of their bulky structures, and hence may have low cytotoxicity. The cyclophanes described herein have an alternating cyclic arrangement of two quadrupolar subunits and two bridging subunits, wherein the quadrupolar subunit has a formula of

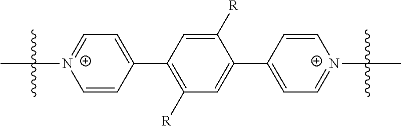

and wherein R is an electron-donating group (EDG). In some embodiments the EDG is an alkoxy. In some embodiments, the EDG is methoxy. In some embodiments, the bridging subunit comprises a para-xylylene linker of formula

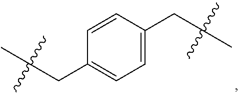 [SMILES: *Cc1ccc(C*)cc1]

In some embodiments, the cyclophane has a formula of

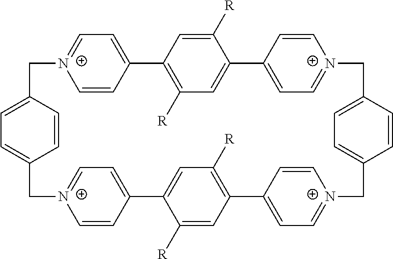

wherein R is an alkoxy.

In some embodiments, the cyclophane has a formula of

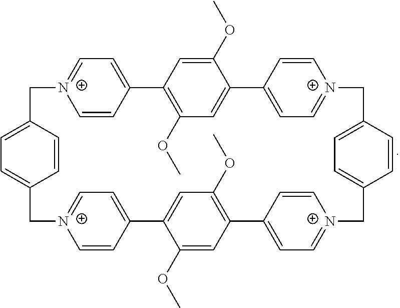 [SMILES: COc1cc2c(OC)cc1-c1cc[n+](cc1)Cc1ccc(cc1)C[n+]1ccc(cc1)-c1cc(OC)c(cc1OC)-c1cc[n+](cc1)Cc1ccc(cc1)C[n+]1ccc-2cc1]

As used herein “chromophore” means a part of the cyclophane that may absorb electromagnetic radiation, suitably in the ultraviolet, visible, or infrared spectral region. The absorbed radiation may stimulate the cyclophane, exciting an electron from one molecular orbital to another higher energy molecular orbital, e.g., from the ground state to an excited state. In some cases, the absorption may be directly detectable. For example, the absorption may be detectable using an absorption or transmission spectroscopy. In other cases, the absorption is indirectly detectable. For example, the cyclophane may undergo a detectable relaxation event such as fluorescence.

In some embodiments, the chromophore is a fluorophore. As used herein “fluorophore” means a part of the cyclophane that may emit electromagnetic radiation as a result of the absorption of the electromagnetic radiation. Suitably the emitted radiation is red-shifted relative to the absorbed radiation. Suitably the emitted radiation may be in the ultraviolet, near-UV, visible, or infrared spectral region. Fluorophores may comprise fused aromatic groups or a multiplicity of n-bonds in a substantially planar and/or cyclic portion of a molecule. Suitably the fluorophore comprises fused aromatic groups such as aryls or heteroaryls.

The quadrupolar subunit comprises a part of the cyclophane that provides stiffness or rigidity to the cyclophane. Suitably, the quadrupolar subunit resists large-amplitude confirmation rearrangement. The quadrupolar subunit comprises a multiplicity of π-bonds in a substantially planar or linear arrangement. In some embodiments, the molecular strut comprises a multiplicity of aromatic groups. The multiplicity of aromatic groups may be covalently bonded vertex-to-vertex or fused together to provide stiffness and rigidity.

Methods, compositions, and kits comprise the cyclophane described herein may be prepared. In some embodiments, the composition may comprise between 1-50 μM of the cyclophane. In some embodiments, the composition may comprise between 1-10 μM of the cyclophane. In some embodiments, the composition for live cell imaging of cyclophane between 1-50 μM is non-cytotoxic. In some embodiments, the composition for live cell imaging comprises between 1-10 μM of the cyclophane.

As demonstrated in the Examples, the composition described above allows for live cell imaging. The methods may comprise incubating cells with a cyclophane described above, irradiating a cell in contact with a composition for live cell imaging, and detecting an emission signal. The cyclophane is stimulated under live cell conditions. Suitably the cells may be incubated with an effective amount of the cyclophane. An effective amount of the cyclophane is an amount of the cyclophane capable of producing a detectable signal after having transfected across a cellular membrane or was otherwise taken up by a cell. The cyclophane is capable of producing a detectable signal under live cell conditions. Suitably, the cell can be contacted with the composition for live cell imaging for a period of time prior to irradiating the cell. In some embodiments, the cells are cancer cells. However, the methods are limited to a particular any particular type of cells.

In some embodiments, detecting the emission signal comprises detecting radiation emitted from the cyclophane internalized within the cell. Because the cyclophanes are non-cytotoxic, the cells may be incubated by an effective amount of the cyclophane without substantial decrease in cell viability or minimal cell death. As used herein, “substantial decrease in cell viability” means viability of incubated cells less than 80% over a period of at least 1 hour. Suitably, cell viability may be at least 80%, 85%, 90%, 91%, 92%, 93%, 94%, 95%, 96%, 97%, 98%, or 99% over a period of 1, 2, 4, 6, 8, 12, 24, 48, 64, or 72 hours. The cyclophanes described herein allow for persistent detection over extended period of time. Suitably the cyclophanes may be detected over periods of at least 5 seconds. Suitably, the cyclophanes may be detected over periods of at least 1, 5, 10, 15, 30, 45, or 60 minutes without substantial loss in intensity. A substantial loss of intensity occurs when the detectable signal is less than half the intensity at the time of measurement than at the initiation of irradiation. Suitably, the cyclophanes may have a detectable intensity of at least 50%, 60%, 70%, 80%, or 90% for at least 1, 5, 10, 15, 30, 45, or 60 minutes after the initiation of irradiation. The stimulated emission may be fluorescence emission detectable in the ultraviolet, visible, or infrared spectral region and detected by methods known in the art such as fluorescence microscopy. The cyclophane may be stimulated by ultraviolet or visible radiation.

In some embodiments, the composition for live cell imaging comprises a counterion. Further, in some embodiments, the composition for live cell imaging comprises a counter ion. Suitably, the counter ion is an anion such as a halide or PF₆⁻. In some embodiments, the composition is a crystalline composition comprising any of the cyclophanes described herein. Suitably the crystalline composition may comprise a counterion such as an anion. In some embodiments, the composition for live cell imaging further comprises a non-cytotoxic carrier.

The kit for live cell imaging comprises a first container containing the above-described composition for live cell imaging and the second container comprises a cell. The kit may further comprise instructions for contacting the composition for live cell imaging with the cell. Further, the kit may describe irradiating the cell in contact with the composition for live cell imaging and detecting an emission signal.

Herein, the rational design and synthesis of a series of fluorescent dyes which contain quadrupolar backbones as major building blocks is described. The acceptor-donor-acceptor (A-D-A) quadrupolar backbones all contain electron withdrawing groups, e.g., alkoxy-substituted electron-rich phenylene rings, in their midriffs, with two electron-deficient rings, i.e., (i) para-substituted phenylene, (ii) pyridine or (iii) pyridinium units, connected symmetrically in a linear fashion by aryl-aryl single bonds. As shown in the Examples, dyes 1-5, pairs of 2,5-substituted n-octyloxy chains, which are attached to the electron-rich donor rings (DRs), not only constitute a means of providing solubility and hydrophobicity, but also act as electron-donating groups. Five different para-substituted EWGs, from weaker to stronger, namely F/CF₃/CN/COOMe/NO₂, were attached to the electron-deficient acceptor rings (ARs), affording fluorescent dyes 1, 2, 3, 4, and 5, respectively. In dyes 6, 7·2PF₆, 8·2PF₆, 9·4PF₆, and 9·4Cl, 2,5-dimethyloxyphenylene units act as the DRs located in their midriffs, whereas pyridine rings and cationic pyridinium rings constitute the ARs located symmetrically at both ends. The dyes cover a wide range of both UV/Vis absorption and fluorescence emission wavelengths, which are correlated to their quadrupolarity. Steady-state and time-resolved absorption and emission experiments were carried out to investigate the photophysical properties of both (i) neutral dyes 1-6 and (ii) cationic dye 9⁴⁺ and its subunit 7²⁺. In 9⁴⁺ in particular, two quadrupolar building blocks are bridged by a pair of para-xylylene linkers, forming a rigid, box-like tetracationic cyclophane. This constitutionally symmetrical cyclophane is readily soluble both in polar organic solvents, e.g., MeCN, Me₂CO, and DMF as its PF₆⁻ salt, and in H₂O as its Cl⁻ salt. Investigations of their excited-state dynamics and mechanisms are indispensable for obtaining feedback and guidance about new optimal design and synthetic strategies. Cell experiments with the addition of the water-soluble tetrachloride 9·4Cl were performed to probe its cytotoxicity profile: given its low toxicity, it was employed in confocal live cell imaging experiments. Our investigations demonstrate that the cyclophane is readily taken up by cells at low treatment concentrations (as low as 1 μM) and can be easily imaged under conditions that sustain living cells.

As used herein, an asterisk “*” or a plus sign “+” may be used to designate the point of attachment for any radical group or substituent group.

The term “alkyl” as contemplated herein includes a straight-chain or branched alkyl radical in all of its isomeric forms, such as a straight or branched group of 1-12, 1-10, or 1-6 carbon atoms, referred to herein as C1-C12 alkyl, C1-C10-alkyl, and C1-C6-alkyl, respectively.

The term “aryl” is art-recognized and refers to a carbocyclic aromatic group. Representative aryl groups include phenyl, naphthyl, anthracenyl, and the like.

The term “aryl” includes polycyclic ring systems having two or more carbocyclic rings in which two or more carbons are common to two adjoining rings (the rings are “fused rings”) wherein at least one of the rings is aromatic and, e.g., the other ring(s) may be cycloalkyls, cycloalkenyls, cycloalkynyls, and/or aryls. Unless specified otherwise, the aromatic ring may be substituted at one or more ring positions with, for example, halogen, azide, alkyl, aralkyl, alkenyl, alkynyl, cycloalkyl, hydroxyl, alkoxy, amino, nitro, sulfuydryl, imino, amido, carboxylic acid, —C(O)alkyl, —CO₂alkyl, carbonyl, carboxyl, alkylthio, sulfonyl, sulfonamido, sulfonamide, ketone, aldehyde, ester, heterocyclyl, aryl or heteroaryl moieties, —CF₃, —CN, or the like. In certain embodiments, the aromatic ring is substituted at one or more ring positions with halogen, alkyl, hydroxy, or alkoxy. In certain other embodiments, the aromatic ring is not substituted, i.e., it is unsubstituted. In certain embodiments, the aryl group is a 6-10 membered ring structure.

The terms “heterocyclyl” and “heterocyclic group” are art-recognized and refer to saturated, partially unsaturated, or aromatic 3- to 10-membered ring structures, alternatively 3- to 7-membered rings, whose ring structures include one to four heteroatoms, such as nitrogen, oxygen, and sulfur. The number of ring atoms in the heterocyclyl group can be specified using 5 Cx-Cx nomenclature where x is an integer specifying the number of ring atoms. For example, a C3-C7 heterocyclyl group refers to a saturated or partially unsaturated 3- to 7-membered ring structure containing one to four heteroatoms, such as nitrogen, oxygen, and sulfur. The designation “C3-C7” indicates that the heterocyclic ring contains a total of from 3 to 7 ring 30 atoms, inclusive of any heteroatoms that occupy a ring atom position.

The terms “alkoxyl” or “alkoxy” are art-recognized and refer to an alkyl group, as defined above, having an oxygen radical attached thereto. Representative alkoxyl groups include methoxy, ethoxy, tert-butoxy and the like.

The term “carbonyl” as used herein refers to the radical —C(O)—.

The term “carboxy” as used herein refers to the radical —COOH or its corresponding salts, e.g. —COONa, etc.

The term “amide” or “amido” as used herein refers to a radical of the form —R¹C(O)N(R²)—, —R¹C(O)N(R²)R³—, —C(O)NR²R³, or —C(O)NH₂, wherein R¹, R² and R³ are each independently alkoxy, alkyl, alkenyl, alkynyl, amide, amino, aryl, arylalkyl, carbamate, cycloalkyl, ester, ether, formyl, halogen, haloalkyl, heteroaryl, heterocyclyl, hydrogen, hydroxyl, ketone, or nitro.

The compounds of the disclosure may contain one or more chiral centers and/or double bonds and, therefore, exist as stereoisomers, such as geometric isomers, enantiomers or diastereomers. The term “stereoisomers” when used herein consist of all geometric isomers, enantiomers or diastereomers. These compounds may be designated by the symbols “R” or “S,” depending on the configuration of substituents around the stereogenic carbon atom. The present invention encompasses various stereo isomers of these compounds and mixtures thereof. Stereoisomers include enantiomers and diastereomers. Mixtures of enantiomers or diastereomers may be designated “(±)” in nomenclature, but the skilled artisan will recognize that a structure may denote a chiral center implicitly. It is understood that graphical depictions of chemical structures, e.g., generic chemical structures, encompass all stereoisomeric forms of the specified compounds, unless indicated otherwise. Compositions comprising substantially purified stereoisomers, epimers, or enantiomers, or analogs or derivatives thereof are contemplated herein (e.g., a composition comprising at least about 90%, 95%, or 99% pure stereoisomer, epimer, or enantiomer.)

Unless otherwise specified or indicated by context, the terms “a”, “an”, and “the” mean “one or more.” For example, “a molecule” should be interpreted to mean “one or more molecules.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≤10% of the particular term and “substantially” and “significantly” will mean plus or minus >10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion additional components other than the components recited in the claims. The term “consisting essentially of” should be interpreted to be partially closed and allowing the inclusion only of additional components that do not fundamentally alter the nature of the claimed subject matter.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### EXAMPLES

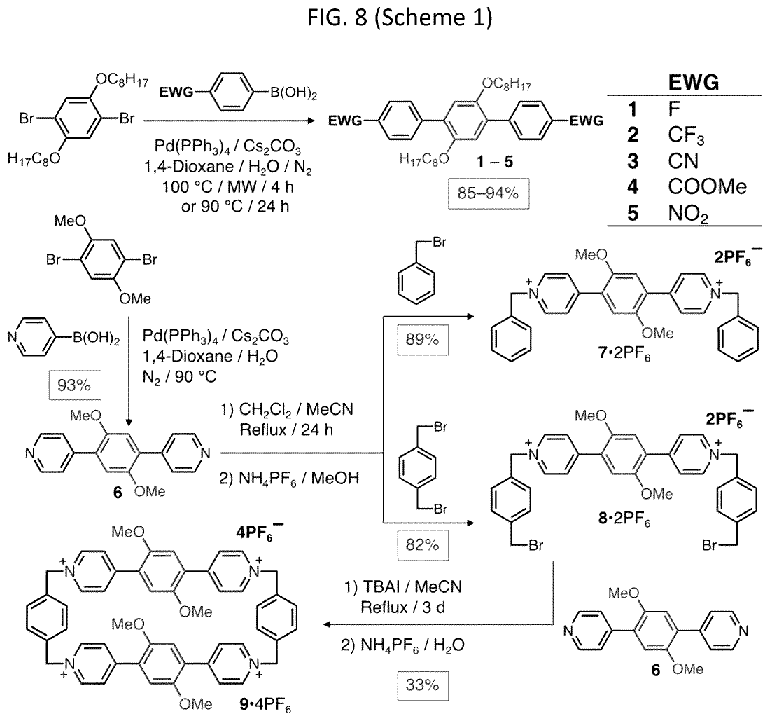

The syntheses of fluorescent dyes 1-6, 7·2PF₆, 8·2PF₆ and 9·4PF₆ are shown in Scheme 1 (FIG. 8). For the syntheses of 1-5, the precursor of the central para-phenylene rings 1,4-dibromo-2,5-dioctyloxylbenzene—was obtained from 1,4-dibromo-2,5-hydroquinone and 1-bromooctane. In order to attach two electron-deficient substituted phenylene rings to both ends of a dioctyloxyphenylene unit located in the midriff, Suzuki couplings⁷² between 1,4-dibromo-2,5-dioctyloxybenzene and (i) 4-fluorophenylboronic acid, (ii) 4-(trifluoromethyl)phenylboronic acid, (iii) 4-cyanophenylboronic acid and (iv) 4-(methoxycarbonyl)phenylboronic acid, respectively, in H₂O/dioxane (1:1) were carried out at 100° C. under an N₂ atmosphere for 4 h in a microwave reactor, affording 1-4, respectively. Dye 5 was obtained from a Suzuki coupling⁷² of 1,4-dibromo-2,5-dioctyloxybenzene with 4-nitrophenylboronic acid at 90° C. under an N₂ atmosphere for 24 h after which dye 6 was obtained from the coupling of 1,4-dibromo-2,5-dimethyloxybenzene and 4-pyridinylboronic acid under the same conditions. Subsequently, S_{N}2 reactions in the presence of an excess of (i) benzyl bromide and (ii) α,α′-dibromo-p-xylene with 6 in CH₂Cl₂/MeCN (1:1) under refluxing conditions for 24 h, followed by counterion exchange with NH₄PF₆, resulted in the formation of dyes (i) 7·2PF₆ and (ii) 8·2PF₆, respectively. In the reaction involving the mixing of 6 and 8·2PF₆ in a ratio of 1:1 in dry MeCN and in the presence of ˜20 mol % tetrabutylammonium iodide (TBAI) heating under reflux was followed by the addition of solid tetrabutylammonium chloride (TBACl) to precipitate the crude product. The crude product, which was subjected to reverse-phase C18 column chromatography, followed by counterion exchange with an excess of NH₄PF₆ in aqueous solution, produced a yellow precipitate. The product was separated by filtration and dried in vacuo to obtain the fluorescent cyclophane 9·4PF₆. Water soluble 9·4Cl was obtained subsequently by counterion exchange in MeCN with an excess of TBACl, followed by a centrifugal separation.

Further evidence for dye-formation comes from single-crystal X-ray diffraction (XRD) analysis. X-Ray quality single-crystals of dyes 1-5 were obtained by slow evaporation of CH₂Cl₂ solutions left open to the air at 298 K. All single crystals had long needle-like shapes and exhibited strong fluorescence under a UV (365 nm) lamp. Some key structural data, such as molecular dimensions, dihedral angles between the adjacent (red and blue) para-phenylene rings, centroid-to-centroid (C-to-C) and plane-to-plane (P-to-P) distances as well as the slip angles⁷³ between a set of neighboring (i) electron-rich donor rings (DRs, red) in their midriffs or (ii) electron deficient acceptor rings (ARs, blue) at their termini are shown in Table 1. The distance between two EWGs parallel to the long axis of the para-terphenylene backbone is defined as the length of the molecule. The width of the molecule is the projection (on the plane which is perpendicular to the axle of the backbone) distances between two terminal carbon atoms in the long n-octyloxy chains. The height of the molecule is the projection (on the plane of the DR) distances between two aromatic carbon atoms in the ARs. The parallel/antiparallel alignment of the long hydrophobic n-octyloxy chains reveals that these interactions play a role in the alignment of the molecules in the superstructures. The plane-to-plane distances between sets of neighboring (i) electron-rich DRs or (ii) electron-deficient ARs lie in the range of 3-4 Å, revealing their intermolecular [π . . . π] stacking.

The DFT calculated structural parameters are in good agreement (Table 1) with the single crystal (super)structures in which dyes were optimized structurally using the crystal (super)structures as the sources of the molecular geometries. The calculated S₁ transition energies for each of dyes exhibit a good correlation with the electron-withdrawing strengths that influences the quadrupolarity of the π-conjugated para-terphenylene backbone. For both the monomers and the dimers, the wavelengths of the calculated absorption bands (from shortest to longest) are matched with the electron-withdrawing propensities (from the weakest to the strongest) of the terminal ARs. The CN-substituted and COOMe-substituted dyes 3 and 4, have similar calculated absorption and emission wavelengths, which correlate with the electron-withdrawing propensities of their EWGs. In order to visualize the interactions between the minimized structures of the dimers of dyes 1-5, the independent gradient model based on the Hirshfeld partition of molecular density⁷⁴ (IGMH) method was used. This computational method plots a surface representing noncovalent interactions between wealdy interacting compounds. The IGMH plots confirm that the spatial pattern of interactions between the substituted para-terphenylene backbones depends on the relative orientations of the aromatic rings. In the case of dyes 1 and 2 (EWG=F and CF₃, respectively), the edge-to-face interactions between the terminal ARs of the dimers result in localized pockets of [CH . . . π] interactions. Non-planar intermolecular co-conformations in the case of 1 and 2 may result from the lack of π-conjugation between their EWGs and aromatic rings. In the case of dyes 3 and 4 (EWG=CN and COOMe, respectively), the face-to-face overlapping between the ARs of the dimers is reflected in extensive [π . . . π] interactions. The NO₂-substituted dye 5, which exhibits the largest face-to-face overlap of all the minimized dimer structures, results in the most extensive surface representing [π . . . π] stacking. Both XRD data and DFT calculations carried out on the solid-state superstructure of dye 5 reveal shorter centroid-to-centroid distances and greater slip angles⁷³ between aromatic rings, raising the possibility of it having significantly stronger [π . . . π] stacking interactions compared with its analogues 1-4.

TABLE 1
Calculated Geometric Parameters of Fluorescence Dyes 1-5

| | Dye | | | | |
|---|---|---|---|---|---|
| | 1 | 2 | 3 | 4 | 5 |
| EWG | F | CF₃ | CN | COOMe | NO₂ |
| Length/Å | 14.1 | 15.6 | 16.6 | 18.5 | 15.4 |
| Width/Å | 21.8 | 24.2 | 23.2 | 13.5 | 25.1 |
| Dihedral Angles/° | ±38 | +53 | ±34 | ±38 | ±47 |
| DR's^{a} C-to-C^{b} | 4.61 | 4.95 | 5.19 | 5.07 | 3.58 |
| Distance/Å | | | | | |
| DR's P-to-P^{c} | 2.86/3.60^{f} | 3.21 | 3.60 | 3.72 | 3.31 |
| Distance/Å | | | | | |
| DR's Slip Angle θ/° | 38/51 | 40 | 44 | 47 | 67 |
| AR's^{d} C-to-C | NA^{g} | NA | 5.48 | 5.60 | 3.52 |
| Distance/Å | | | | | |
| AR's P-to-P | NA | NA | 2.11 | 2.32 | 3.21 |
| Distance/Å | | | | | |
| AR's Slip Angle θ/° | NA | NA | 23 | 24 | 66 |

^{a}DR denotes Donor Ring.
^{b}C-to-C denotes Centroid-to-Centroid.
^{c}P-to-P denotes Plane-to-Plane.
^{d}AR denotes “Acceptor Ring”.
^{e}Distances are measured by centroid-to-plane distances because of a non-paralleled packing.
^{f}NA denotes the plane-to-plane distance is Not Available because of the perpendicular AR orientations in the dimers

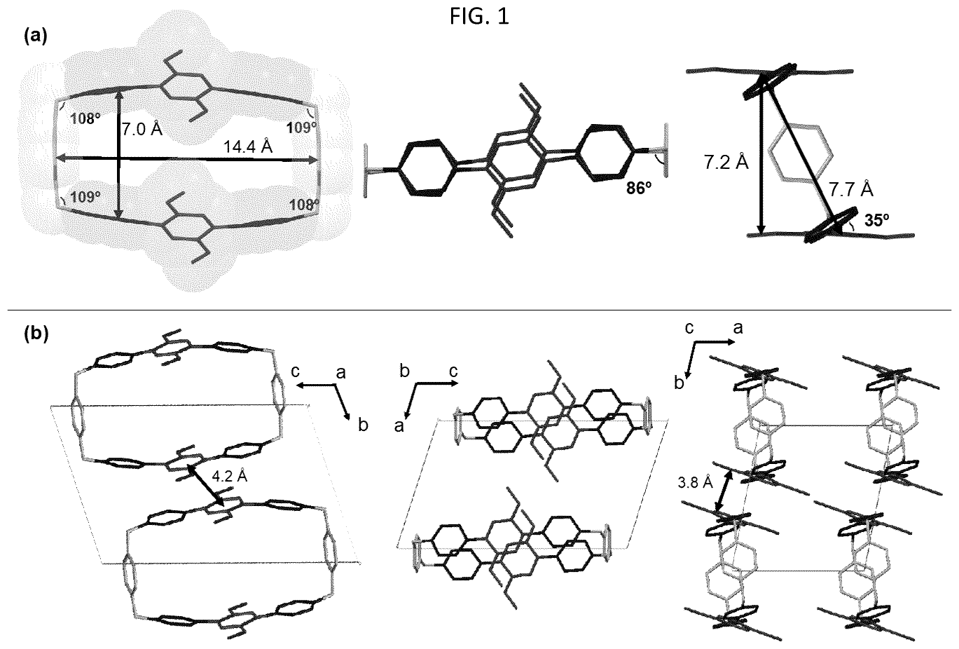

A single crystal of the fluorescent tetracationic cyclophane 9·4PF₆ was obtained by vapor diffusion of ⁱPr₂O into a MeCN solution over the course of a week. The solid-state structure reveals (FIG. 1a) a box-like tetracationic cyclophane, measuring 14.4 Å in length and 7.0 and 7.7 Å in width at its periphery and center, respectively. The two dihedral angles between the adjacent electron-deficient pyridinium and electron-rich dimethylphenylene rings are both 35°, resulting in a shorter distance (7.2 Å) as the plane-to-plane distance between two central rings which is greater than the average dihedral angle⁷⁵ (˜30°) in ExBox⁴⁺. The extended solid-state superstructure of 9⁴⁺ reveals (FIG. 1b) that the dimethylphenylene rings are facing each other, with a centroid-to-centroid distance of 3.8 Å and a plane-to-plane distance of 4.2 Å. The overall superstructure of 9⁴⁺ reveals a parallel arrangement of the tetracationic cyclophanes.

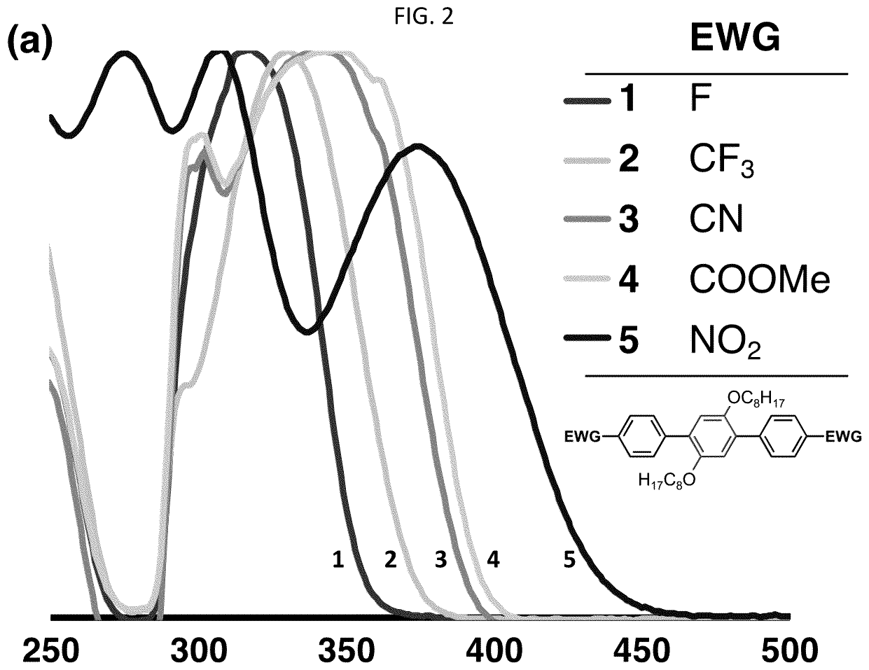

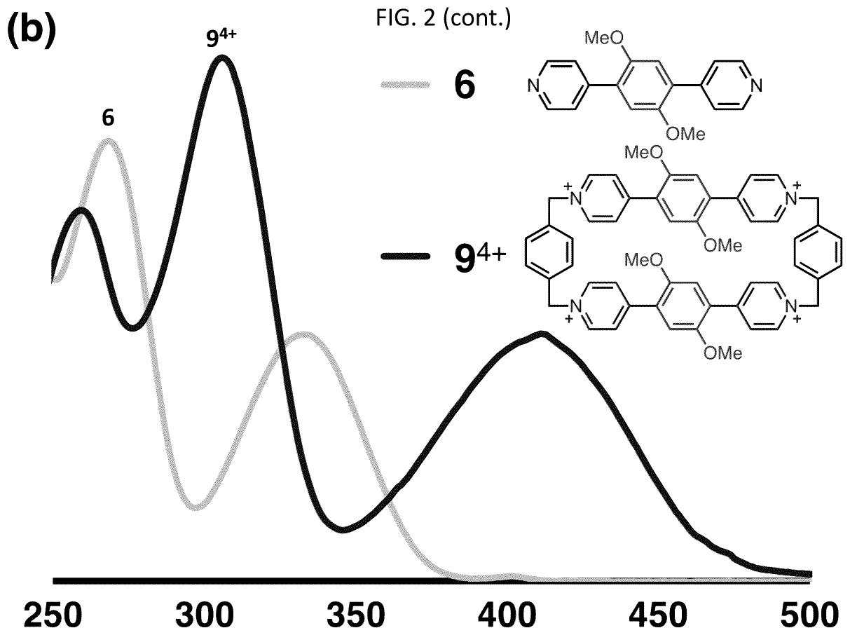

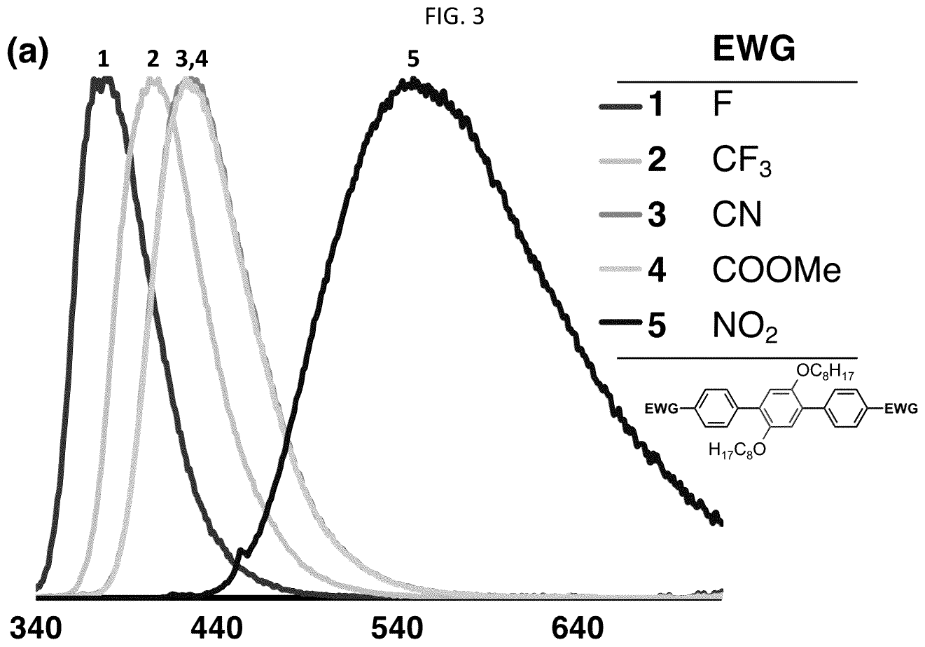

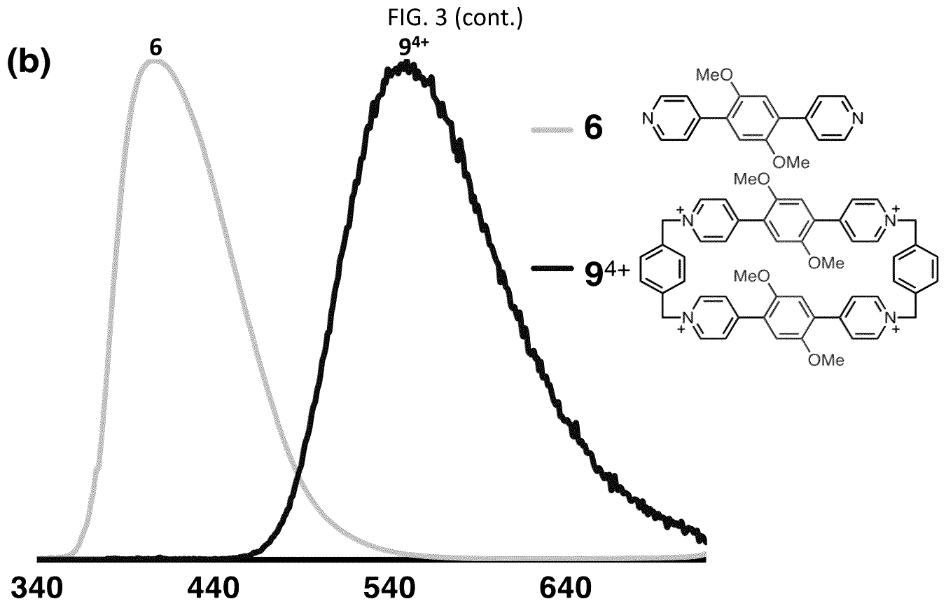

Fluorescent dyes 1-6, 7·2PF₆, 8·2PF₆, 9·4PF₆ and 9·4Cl were dissolved in THF (1-5), MeCN (6, 7·2PF₆, 8·2PF₆ and 9.4PF₆) and H₂O (9.4Cl), respectively, to afford 10 μM solutions prior to spectroscopic analysis. For comparison, their normalized (i) UV/Vis absorption (FIG. 2) and (ii) the fluorescence emission (FIG. 3) spectra of quadrupolar dyes are overlayed, displaying a large range of S₁ absorbance and emission maxima, which rely highly on their quadrupolarity that is correlated to the electron-deficiency of the ARs.

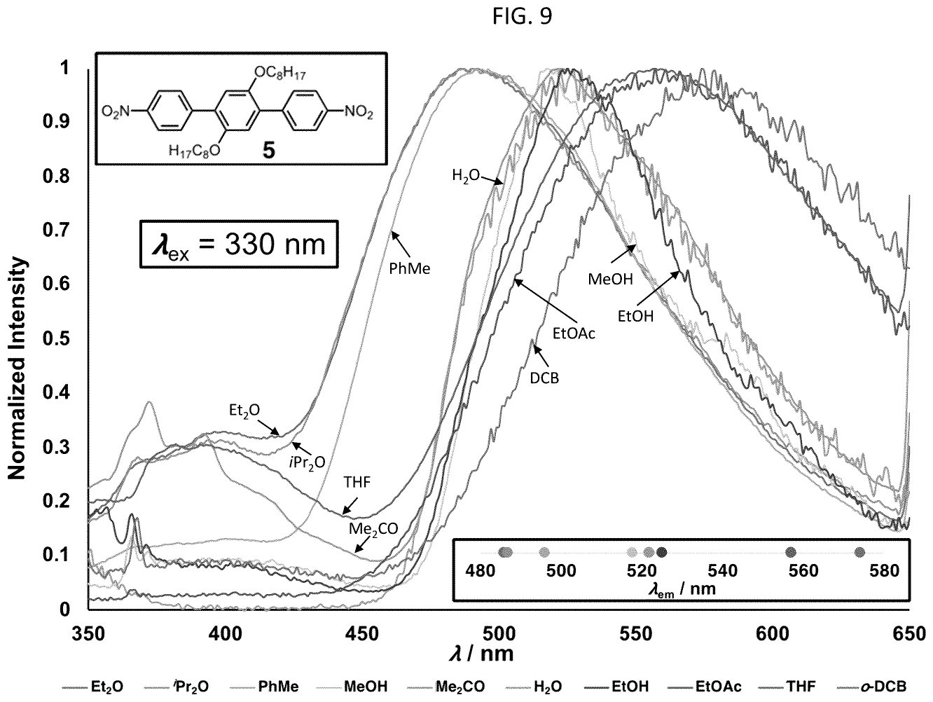

For EWG-substituted dyes 1-5, both their maximum S₁ absorption and emission wavelengths are correlated with a polar effect, an observation which depends on the electron-withdrawing propensities of their EWGs. The F-substituted dye 1 displayed a deep violet emission at λₑₘ=380 nm, with a UV absorption band centered on 316 nm. With the attachment of relatively stronger EWGs, i.e., CF₃/CN/COOMe, respectively, 2, 3 and 4 display violet/blue emissions with bathochromic shifts in absorption. All of dyes 1-4 exhibit weak or moderate solvatochromic effects, that correlate with the strength of the EWGs as well. Moreover, dyes 3 and 4 have similar spectroscopic features in both absorption and emission spectra, resulting from their related EWGs. The NO₂-substituted dye 5 exhibits unique photophysical properties: in addition to having significantly red-shifted absorption and emission bands, it also displays (FIG. 9) a wider solvatochromic range and no fluorescence in some of nonprotic solvents with low polarities.

By comparing the absorbance and emission maxima of the dyes 6, 7·2PF₆, 8·2PF₆, 9·4PF₆ and 9·4Cl—where the pyridine and substituted pyridinium units act as the electron-deficient ARs—the wavelength-quadrupolarity correlation is confirmed. Dye 6 has similar absorption and emission properties to those of CF₃-substituted dye 2 as a result of the similar electron deficiencies of their ARs. When the pyridines are quaternized to afford cationic pyridinium units, the polar effect is promoted dramatically, resulting in obvious bathochromic shifts in both the absorption and emission spectra. All the pyridinium-substituted dyes—namely, 7·2PF₆, 8·2PF₆, 9·4PF₆ and 9·4Cl—share a similar feature in their spectra, indicating that the quadrupolar extended-bipyridinium building block is the chromophore. The dramatic red shift in the absorption and emission of the pyridinium-containing series of dyes compared to the pyridine-substituted dye 6 originates⁷⁶ most likely from substantial charge transfer (CT) interactions between the pyridinium AR and dimethoxyphenylene DR, resulting in a CT absorption band with a maximum between 410-413 nm. They all emit in green light (˜545 nm) from this CT state. CT-Interactions have been probed more deeply using time-resolved spectroscopies.

The excited-state properties of these quadrupolar dyes were investigated using transient absorption (TA) spectroscopy. The transient kinetics were analyzed globally and all-time constants are given in Table 2. The TA data of dyes 1-4 and 6 in MeCN with lₑₓ=350 nm (FIGS. 9-12 and 15) show similar spectra with the same general electronic evolution, though with differing kinetics. Following excitation, strong excited-state absorption features appear between ˜450-500 nm along with a strong single peak in the near-infrared region, both of which are associated with Sₙ←S₁ absorptions. The visible bands redshift over the following ˜100 ps, while the near-infrared band peaks first blueshift in the initial ˜10 ps before settling. These near-infrared absorption bands are similar to those observed^{59,60} in extended bipyridinium compounds. Following these shifts, the excited states decay via emission with lifetimes between 3-4 ns as confirmed by time-resolved fluorescence (TRF) spectroscopy. The spectral shape of the transient species is generally maintained throughout their lifetimes, implying that the dynamics in each dye all occur on a single electronic excited state (S₁) prior to emission. The spectral shifts at early times may arise due to excited-state symmetry breaking⁷⁷⁻⁷⁸ in the quadrupolar dyes, wherein fluctuations in the instantaneous electrostatic environment afforded by the solvent transiently favor wavefunction localization on one side of the symmetric molecule, creating an excited state with a large dipole moment that is associated with the Stokes shift observed⁷⁹ in the fluorescence spectra. This localization can lead to changes in the transient absorption spectra as a result of the breakdown^{42,80} of the Laporte rule. The shifts at longer times may arise from solvent or structural relaxation of the dyes.

TABLE 2
Rate constants for dyes in from TA data of Dyes 1-6, 7•2PF₆ in MeCN;
9•4PF₆ and 9•4Cl in MeCN and H₂O, respectively.

| | k₁ | k₂ | k₃ | k₄ |
|---|---|---|---|---|
| 1 | (5.4 ± 0.6 ps)⁻¹ | (83 ± 7 ps)⁻¹ | (3.38 ± 0.03 ns)⁻¹ | (155 ± 3 ns)⁻¹ |
| 2 | (1.4 ± 0.3 ps)⁻¹ | (85 ± 2 ps)⁻¹ | (3.16 ± 0.01 ns)⁻¹ | (150 ± 2 ns)⁻¹ |
| 3 | (0.8 ± 0.3 ps)⁻¹ | (99 ± 2 ps)⁻¹ | (4.23 ± 0.02 ns)⁻¹ | (314 ± 1 ns)⁻¹ |
| 4 | (0.7 ± 0.3 ps)⁻¹ | (132 ± 7 ps)⁻¹ | (3.80 ± 0.01 ns)⁻¹ | (210 ± 2 ns)⁻¹ |
| 5 | (4.3 ± 0.3 ps)⁻¹ | (28 ± 2 ps)⁻¹ | (102.7 ± 0.3 ns)⁻¹ | — |
| 6 | (0.6 ± 0.3 ps)⁻¹ | (52 ± 1 ps)⁻¹ | (4.05 ± 0.02 ns)⁻¹ | (163 ± 2 ns)⁻¹ |
| 7•2PF₆ | (1.4 ± 0.3 ps)⁻¹ | (132 ± 3 ps)⁻¹ | (8.78 ± 0.03 ns)⁻¹ | (485 ± 50 ns)⁻¹ |
| 9•4PF₆ | (1.4 ± 0.3 ps)⁻¹ | (188 ± 4 ps)⁻¹ | (3.45 ± 0.01 ns)⁻¹ | (450 ± 70 ns)⁻¹ |
| 9•4Cl | (1.4 ± 0.3 ps)⁻¹ | (188 ± 4 ps)⁻¹ | (3.45 ± 0.01 ns)⁻¹ | — |

The values of Φ_{F} in solution generally increase with the strength of the EWG in dyes 1-4. The total (relaxed) excited-state decay rates are much less sensitive to this effect, though a clear trend is observed when this rate is decomposed into its radiative (k_{R}) and non-radiative (k_{R}) contributions (Table 3). The radiative decay rate constants increase from k_{R}=(26 ns)⁻¹ to (4.9 ns)⁻¹ from 1 to 4, consistent with the increase in fluorescence quantum yields (Φ_{F}), though no obvious trend is seen in the non-radiative decay times. Dye 6 shows an intermediate k_{R} value, though one of the higher Φ_{F} in the series, despite the fact that the structural differences between 6 and the other dyes makes comparison difficult.

TABLE 3
Quantum Yield (Φ_{F}) and Radiative and non-radiative
decay rate constants of Dyes 1-6, 7•2PF₆ in MeCN; 9•
4PF₆ and 9•4Cl in MeCN and H₂O, respectively.

| | Φ_{F} | k_{R} | k_{NR} |
|---|---|---|---|
| 1 | 0.13 | (26 ± 1 ns)⁻¹ | (3.89 ± 0.02 ns)⁻¹ |
| 2 | 0.56 | (5.64 ± 0.05 ns)⁻¹ | (7.2 ± 0.1 ns)⁻¹ |
| 3 | 0.81 | (5.22 ± 0.03 ns)⁻¹ | (22.3 ± 0.6 ns)⁻¹ |
| 4 | 0.78 | (4.87 ± 0.03 ns)⁻¹ | (17.3 ± 0.4 ns)⁻¹ |
| 5 | <0.005 | <(0.9 ns)⁻¹ | >(4 ps)⁻¹ |
| 6 | 0.63 | (6.43 ± 0.05 ns)⁻¹ | (11.0 ± 0.2 ns)⁻¹ |
| 7•2PF₆ | 0.76 | (11.6 ± 0.1 ns)⁻¹ | (36.6 ± 0.8 ns)⁻¹ |
| 9•4PF₆ | 0.28 | (12.3 ± 0.2 ns)⁻¹ | (4.79 ± 0.03 ns)⁻¹ |
| 9•4Cl | 0.15 | (17.9 ± 0.6 ns)⁻¹ | (3.16 ± 0.02 ns)⁻¹ |

k_{obs} = k₃ for all dyes except 5, where k_{obs} = k₁
k_{R} = k_{obs}Φ_{F}
k_{NR} = k_{obs}(1 − Φ_{F})

The NO₂-substituted dye 5, however, shows markedly different dynamics from the others in both MeCN and PhMe solutions, when excited at 350 nm. In the polar solvent MeCN, the initially excited state appearing near 380 nm is replaced by a strong peak at 505 nm in 4.3±0.3 ps, which is attributed to CT involving the NO₂ group. This ultrafast S₁ decay is consistent with the measured near-zero Φ_{F} (Table 3). Following some relaxation, this CT state decays back to the ground state in 102 ns. In contrast, when excited in low-polarity solvent PhMe, dye 5 shows a more structured S₁ state that decays in 7.9±0.3 ps to a different state with excited-state absorption peaks at 509 and ˜700 nm. This state decays in 18 ns to a triplet state with a diffusional quenching-limited lifetime of 1 s in deaerated solution. The dramatic dependence on the solvent polarity and the modulation of lifetimes corroborates the assignment of this nanoseconds-lived species is a CT state. The appearance of a triplet recombination product in PhMe also supports this claim, as the destabilization of the CT state in a lower polarity solvent makes recombination to this state energetically feasible, unlike for the highly stabilized CT state in MeCN.

The Φ_{F} of 9·4PF₆ and 9·4Cl in the solid-state (powder) following 414 nm excitation were found to be 0.030±0.005 and 0.016±0.005, respectively. A similar decrease in Φ_{F} with counterion was observed in solution (0.28 for 9·4PF₆ in MeCN compared to 0.15 for of 9·4Cl in H₂O), suggesting that interaction with the chloride is abbreviating the excited-state lifetime (see below). The order-of-magnitude decrease moving from solution to the solid state is most likely a result of the increased interactions between closely packed chromophores quenching the emission, as is commonly observed⁸¹⁻⁸⁴ in molecular solids.

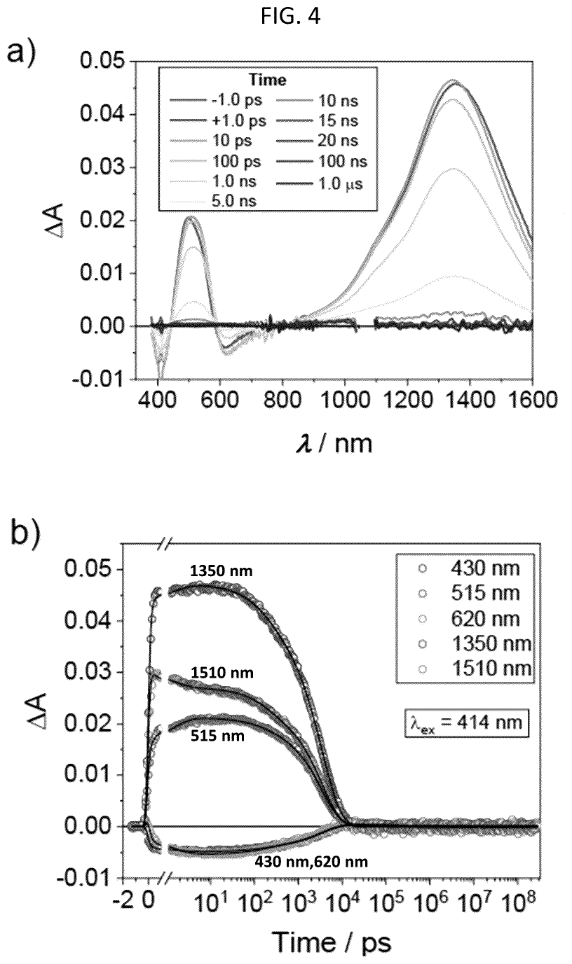

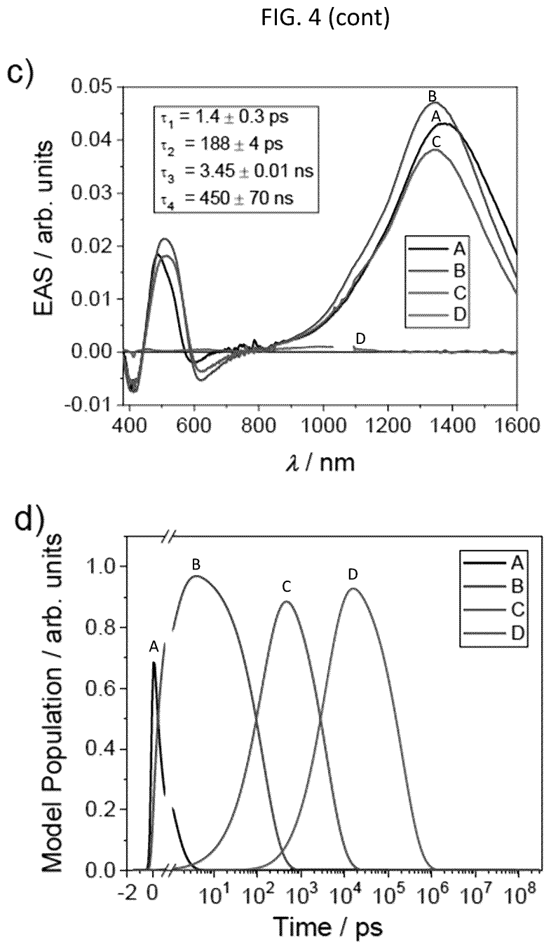

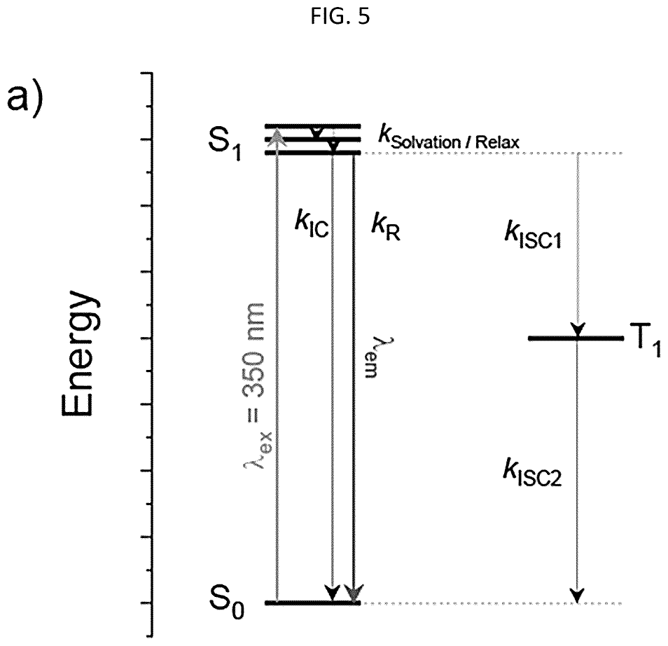

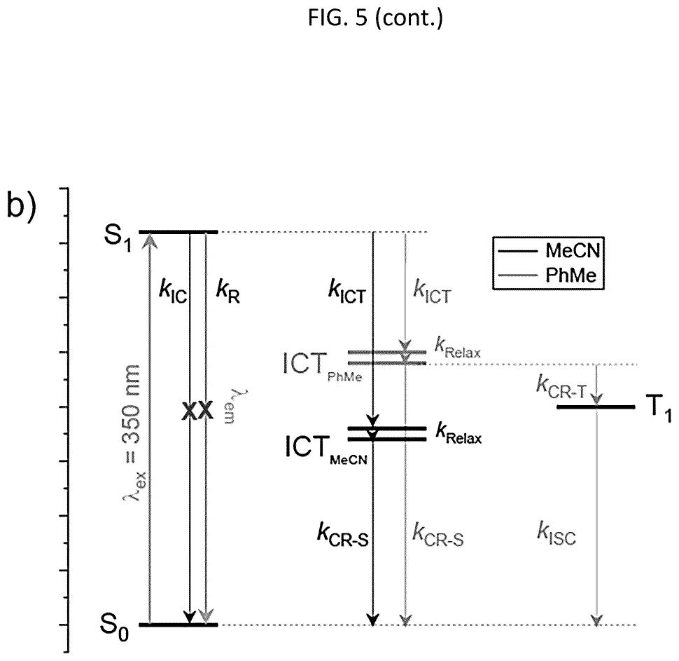

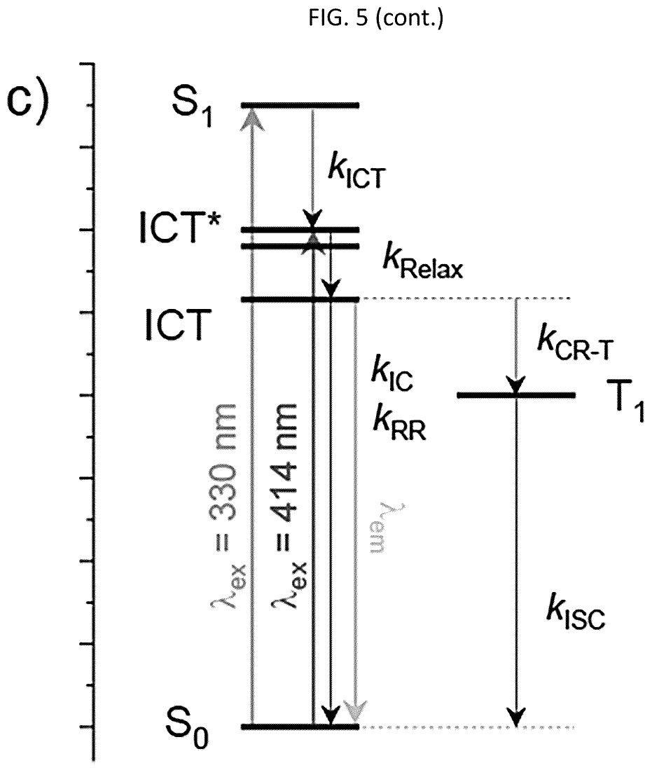

The excited-state dynamics of the tetracationic cyclophane 9·4PF₆ and its subunit 7·2PF₆, which both contain extended bipyridinium units are shown in and are quite different from those of dyes 1-6 in MeCN. The TA spectra of 7·2PF₆ (available in manuscript) and 9·4PF₆ (FIG. 4), following excitation of their CT absorption bands at 414 nm, reveal the rapid appearance of strong excited-state absorption features at 506 and 1356 nm, as well as stimulated emission with an apparent minimum at 618 nm. The excited-state absorption features are similar to those⁵⁹ of ExBox⁴⁺, though with the addition of a strong stimulated emission from radiative recombination of the CT state. This CT state is likely between the electron-donating dimethoxyphenylene unit and an adjacent electron-deficient pyridinium, as the same absorption and transient features are observed in both the tetracationic cyclophane 9·4PF₆ and its subunit 7·2PF₆; there is no evidence of involvement⁸⁵ from the para-xylylene linker. The formation of a CT state from a symmetric A-D-A system also relies on excited-state symmetry breaking as discussed above, where the same fluctuations that induce wavefunction localization in the neutral dyes also favor charge separation along one side of the molecule. In the TA spectra, the minimum of the bleach is consistent with the red-shifted steady-state emission of both 7·2PF₆ and 9·4PF₆ in MeCN, distorted by the addition of a strong, positive excited-state absorption near 508 nm. These signals shift subtly and decay over the next several hundred picoseconds as the rigid tetracationic cyclophane 9·4PF₆ undergoes modest structural changes to accommodate the CT excited state, prior to decaying radiatively with a lifetime 3.45±0.01 ns. The lifetime of the dicationic 7·2PF₆ excited state is 8.78±0.03 ns. Both lifetimes were again corroborated by TRF spectroscopy. The shorter lifetime exhibited by 9·4PF₆ is most likely a consequence of the distortions forced upon the para-xylylene linkers by the box-like geometry of the tetracationic cyclophane. Indeed, while the radiative decay rate is quite similar between 7·2PF₆ and 9·4PF₆ in MeCN, the non-radiative rate in 9·4PF₆ is more than seven times faster, resulting in the reduced Φ_{F}. Excitation of the dimethoxyphenylene-substituted extended bipyridinium units at 330 nm in both 7·2PF₆ and 9·4PF₆ yields very similar data to that from the direct excitation of the CT band, indicating that intramolecular CT occurs within the ˜300 fs instrument response. Following decay of the CT state, a small amount of the triplet state forms, showing a weakly absorbing feature near 458 nm: more triplet is generated in 7·2PF₆ than in 9·4PF₆ for the simple reason that the longer CT state lifetime enables competition from intersystem crossing. In H₂O, tetracationic cyclophane 9·4Cl shows similar spectral features, but with a shorter CT state lifetime (2.69±0.02 ns), consistent with the reduced Φ_{F} (0.15) and no triplet formation in contrast to 9·4PF₆ in MeCN, most likely because of the short lifetime inhibiting spin mixing. While the decreased lifetime may be a result of the higher polarity aqueous environment,⁶⁰ a similar reduction in Φ_{F} was observed in the solid state discussed above, implying that the counterions may be playing an important role. Since the emission in 7²⁺ and 9⁴⁺ originates from a CT state, the electrostatic interactions of the different counterions with this state can alter recombination kinetics: indeed, in solution the non-radiative rate in 9·4Cl decreases more than the concomitant increase in the radiative rate, while still yielding a faster overall decay than 9·4PF₆ (Table 2). The dynamics of all dyes are summarized in FIG. 5.

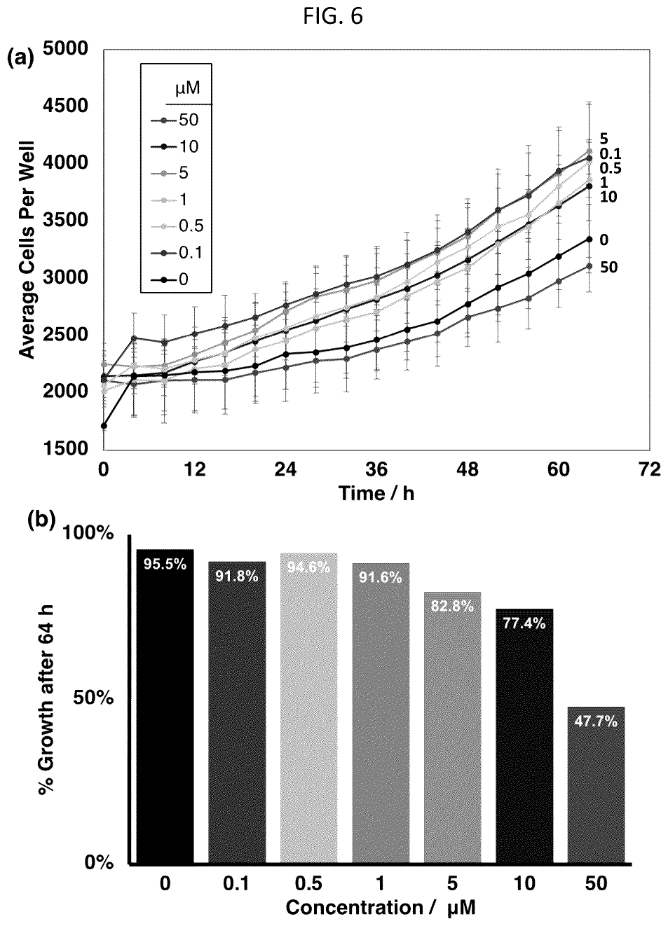

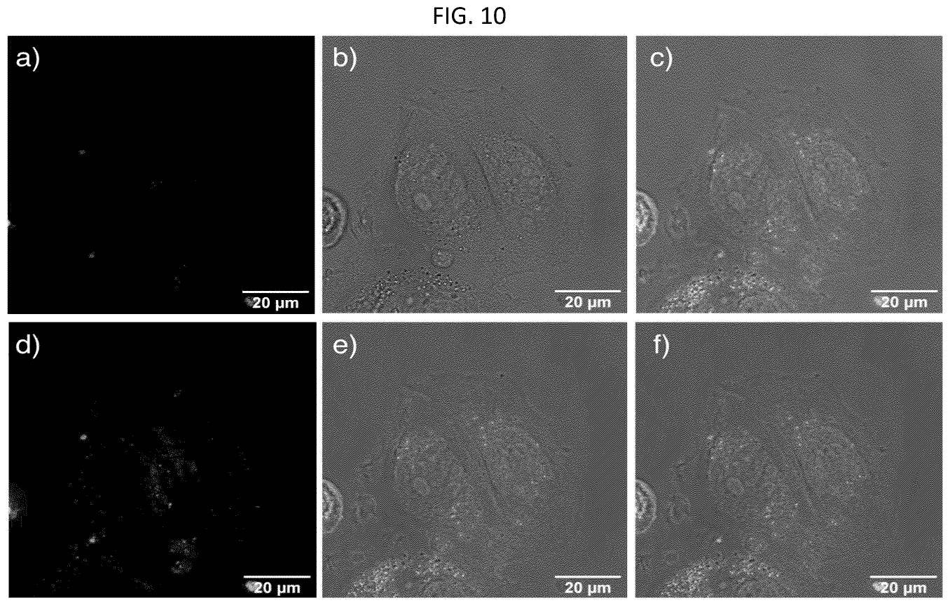

Small molecular dyes are known⁸⁶ to intercalate with the DNA on account of electrostatic and base-pair interactions. The presence of these interactions inhibits enzyme function, elevating the cytotoxicity in living cells. To test the cytotoxicity of dye 9·4Cl, (FIG. 6) a series of cell uptake and viability experiments using MCF-7 breast cancer cells were performed. When the cells were treated with 9·4Cl at concentrations from 1-50 μM, the dye was readily taken up by cells. Moreover, the cells were viable and treatments of up to 10 μM concentration are non-cytotoxic for up to 64 h post-treatment. At low concentrations (up to 1 μM, FIG. 10), the growth of the cells is comparable with that of non-treated control cells. Cell growth decreases gradually at concentrations of 5 μM and above. While cell growth appears impaired at higher concentrations, minimal cell death is observed.

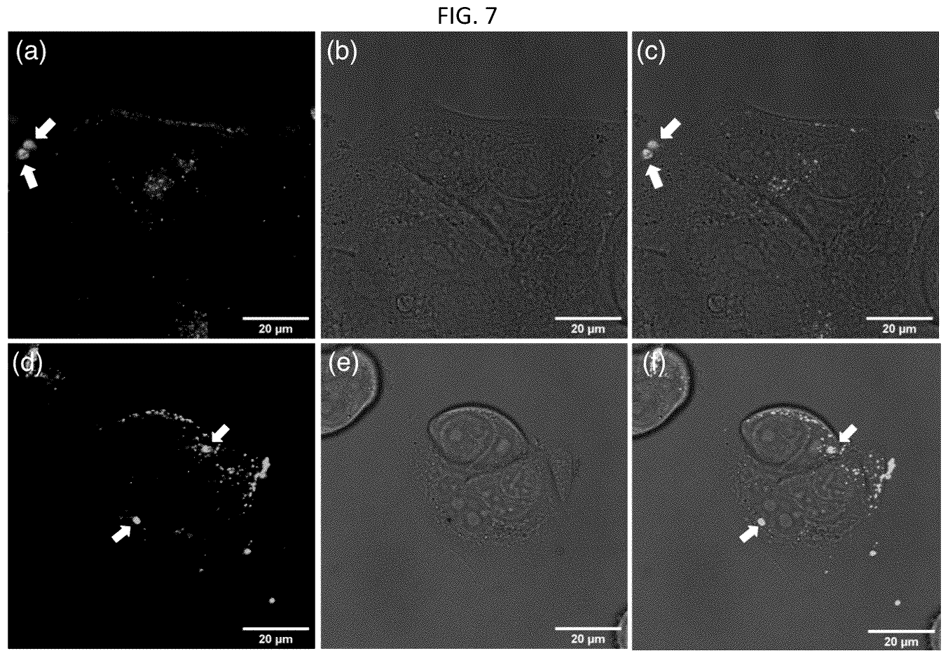

Because of its low cytotoxicity and emission (FIG. 3) in the green region (548 nm) at micromolar concentrations (Φ_{F}=0.15), water-soluble 9·4Cl was subjected to live cell imaging with MCF-7 breast cancer cells. Living cells treated with the tetracationic cyclophane at 50 and 20 μM (FIG. 7) and as low as 1 μM (FIG. 10) concentrations, were imaged by laser scanning confocal microscopy. The dye fluoresces brightly in cells when excited with blue excitation light (405 nm laser) and emits strongly in the green region (500-650 nm). As a result of the significantly low cytotoxicity profile of the cyclophane and the tolerance of cells for live cell imaging at low concentrations, as well as its nanoconfined nature, 9·4Cl holds out promise of applications such as (i) photoprotection and generation of singlet oxygen to kill cancer cells during photodynamic therapy and (ii) supramolecular drug encapsulation and subsequent release under the triggers of chemical stimuli or light.

### CONCLUSIONS

A series of fluorescent dyes, containing electron-withdrawing group-substituted para-terphenylene and extended-bipyridinium building blocks, has been designed and synthesized. By keeping the same alkoxy-substituted electron-rich phenylene rings in their midriffs, the differences in the electron-deficient rings at their termini of the backbone influence their acceptor-donor-acceptor (A-D-A) quadrupolar arrays with modular molecular polarizabilities. Dyes 1 and 2, which contain relatively weaker EWGs (i.e., F and CF₃, respectively) without π-conjugation, as well as the extended bipyridine-substituted 6, result in their (i) higher S₁ transition energies, (ii) shorter wavelengths of fluorescence emission (λₑₘ) and UV/Vis absorption (λₘₐₓ) and (iii) less pronounced solvatochromism. The acceptor rings at the termini of 3 and 4 (EWG=CN and COOMe, respectively) have moderate electron deficiency, resulting in the dyes exhibit relatively (i) lower S₁ transition energies, (ii) longer λₑₘ and λₘₐₓ and (iii) more pronounced solvatochromism compared with 1 and 2. Neutral dyes 1-4 and 6 in MeCN show similar transient absorption (TA) spectra with the same general electronic evolution. The values of fluorescence quantum yields (Φ_{F}) in solution generally increase with the strength of the EWG in dyes 1-4, an observation which is consistent with the radiative decay rate constants k_{R}. Dye 5, which contains significantly stronger electron-withdrawing NO₂ groups on each of its acceptor rings, displays dynamic photophysical behavior that is highly dependent on the nature of the solvent. It emits green light by absorbing blue light, eliciting red-shifted absorption and emission bands, as well as exhibiting a significant strong solvent effect: its λₑₘ has a relatively wide range in addition to the lack of fluorescence in low polarity solvents. Its different dynamics from the other neutral dyes have been revealed by TA spectroscopy in both MeCN and PhMe solutions.

Extended bipyridinium-substituted dyes 7²⁺ 8²⁺ and 9⁴⁺ all have cationic quadrupolar backbones in contrast to the original neutral extended bipyridine dye 6. As a result of the electron-rich dimethoxyphenylene rings located in the midriffs of these cationic dyes, a more significant push-pull effect is produced, leading to a larger quadrupole. It follows that cationic dyes exhibit more pronounced red-shifted absorbance and emission maxima, rendering them similar to the NO₂-substituted dye 5. Single-crystal X-ray analysis of the tetracationic cyclophane 9⁴⁺ reveals a symmetrical rigid box-like structure with a cavity, in addition to strong intermolecular [π . . . π] stacking interactions at the supramolecular level. Time-resolved femtosecond and nanosecond transient absorption (fsTA and nsTA) and fluorescent emission (TRF) spectroscopies reveal intramolecular electron transfer between the dimethoxyphenylene and pyridinium rings in both the linear 7²⁺ and box-like 9⁴⁺ following excitation of the charge transfer absorption band at 414 nm. Spectra of the extended bipyridinium units, obtained on direct excitation at 330 nm of the charge transfer bands in both 7²⁺ and 9⁴⁺, display similar spectroscopic features, indicating that intramolecular charge transfer occurs within the ˜300 fs instrument response. The non-cytotoxicity profile of the water-soluble 9·4Cl has been demonstrated and in vitro live cell confocal microscopic images have been obtained that demonstrate cell uptake at relatively low concentrations.

This systematic investigation of A-D-A quadrupolar chromophores will inspire readers to design and synthesize new generations of organic fluorescent materials. The functionalized para-terphenylene and extended bipyridinium units constitute simple backbones that are easy to modify, making them excellent platforms to modulate and fine-tune their photophysical properties. Excited-state symmetry breaking in centrosymmetric A-D-A dyes has been shown to correlate with large changes in the quadrupole moment in non-polar media, and can be tuned³¹ by modulating the electron acceptor, such as by using EWGs. The push-pull interactions between the electron-rich alkoxyphenylene midriff and the flanking EWG-substituted phenylene termini are also similar to the effects seen in non-fullerene acceptors in organic photovoltaic devices, such as those using indacenodithiophenes like ITIC,⁸⁷⁻⁸⁸ where the magnitude of the quadrupole moment has been shown to correlate⁸⁹ with the charge separation yield in organic photovoltaic devices. The push-pull effect can be further modulated⁸⁸ by the solvent, which has significant implications for its use in devices where the organic thin film produces a low-polarity environment that can be altered⁸⁷⁻⁹⁰ by the quadrupole moment of the surrounding chromophores. Thus, the quadrupole moment can play a determining role in the excited-state and charge-separation dynamics of these dyes. Furthermore, rigid box-like fluorescent cyclophanes⁶³ could incorporate appropriate photosensitizers to form host-guest complexes, which could lead to the development of stimuli-response photosensors capable of being used in photodynamic therapy in the treatment of cancer.

### A. Materials/General Methods/Instrumentation

Fluorescent dyes were dissolved in the appropriate solvents to afford 1 mM solutions prior to spectroscopic analysis. A portion of 30 μL of a 1 mM solution was diluted by adding a selected solvent to a sample with a total volume of 3000 μL, affording a 1×10⁻⁵ M solution. UV/Vis Absorption spectra were recorded in glass cuvettes on a UV-3600 Shimadzu spectrophotometer. Steady-state emission spectra were acquired in quartz cuvettes with optical path-lengths of 10 mm containing the solution being analyzed using a HORIBA Fluoromax4 spectrofluorometer, which was equipped with an integrating sphere for determining the absolute photoluminescence quantum yield.

Steady-state and time-resolved emission spectra for dyes 1-6, 7·2PF₆ and 9·4PF₆ were acquired using a HORIBA Fluorolog-3 spectrofluorometer, equipped with a time-correlated single photon counting (TCSPC) module (diode laser excitation at λ=375 nm) and an integrating sphere, which was used for absolute photo-luminescence quantum yield determinations. Picosecond time-resolved fluorescence measurements were recorded using a commercial direct-diode-pumped 100 kHz amplifier (Spirit 1040-HE, Spectra-Physics), producing a fundamental beam of 1040 nm (350 fs, 12 W) which was used to pump a non-collinear optical parametric amplifier (Spirit-NOPA, SpectraPhysics) capable of delivering tunable, high-repetition-rate pulses with pulse widths as short as sub-20 fs. Dyes 1-6, 7·2PF₆ and 9·4PF₆ were excited with 350 nm, 2 nJ laser pulses. Fluorescence was detected using a Hamamatsu C4780 Streakscope as previously described in the literature. Samples were prepared in 2-mm quartz cuvettes. All data were acquired in the single-photon-counting mode using the Hamamatsu HPD-TA software. The temporal resolution was approximately 2% of the sweep window. Single wavelength kinetic analysis was performed using a nonlinear least-squares fit to a sum of exponentials convoluted with an instrument response function. Visible and near-infrared femtosecond and nanosecond transient absorption (fsTA and nsTA, respectively) spectroscopies were performed following descriptions already recorded in the literature. The 330 nm, ˜100 fs pump pulses were generated at 1 μJ per pulse using a commercial collinear optical parametric amplifier (TOPAS-Prime, Light-Conversion, Ltd.); 414-nm pump pulses were obtained by second-harmonic generation of the 828 nm fundamental. The pump polarization was randomized using a commercial depolarizer (DPU-25-A, Thorlabs, Inc.) to eliminate any orientational dynamics resulting from the experiment. Spectra were collected on commercial spectrometers (customized Ultrafast Systems Helios and EOS spectrometers, for fsTA and nsTA, respectively) for each time window. All samples were stirred to avoid localized heating or degradation effects. The optical density was maintained at 0.6 for all samples.

X-Ray quality single-crystals of dyes 1-5 were obtained by slow evaporation of CH₂Cl₂ solutions open to the air at 298 K. The tetrakis(hexaflurophosphate) salt of the tetracationic cyclophane 9⁴⁺ was dissolved in MeCN at 298 K and the mixture was passed through a 0.45 m filter separately into three 1-mL tubes. The tubes were placed together in a 20-mL vial containing ⁱPr₂O (˜3 mL) and the vial was capped. Slow vapor diffusion of ⁱPr₂O into the solution of 9·4PF₆ in MeCN over the course of a week yielded yellow single crystals. A suitable crystal was selected and it was mounted on a MITIGEN holder with Paratone oil on (i) a XtaLAB Synergy R, DW system, HyPix or (ii) a Bruker and APEX-II CCD diffractometer.

MCF-7 Cells were plated in a 96-well culture plate at a density of 0.01×10⁶ cells per well in Dulbecco's modified eagle medium (DMEM) media with 10% fetal bovine serum (FBS) and 1% Penicillin-Streptomycin. Cells were cultured for 24 h then treated with the compounds at a range of concentrations from 0.1-50 μM. Upon treatment, cells were placed in a BioTek LionheartFX system, where they were imaged at 4× magnification every 3 h for 72 h under standard culture conditions (37° C., 5% CO₂). Phase contrast images were processed and analyzed with BioTek Gen5 analysis software to identify cell number at each time point during the culture period.

### B. Synthesis

1,4-Dibromo-2,5-dioctyloxybenzene: 2,5-Dibromohydroquinoe (8.12 g, 30.3 mmol) and 1-bromooctane (20.9 g, 108 mmol) were dissolved in dry Me₂CO (200 mL) and K₂CO₃ (25.5 g, 184 mmol) was added. The mixture was heated under refluxing at 80° C. for 36 h. After cooling to room temperature, the solvent was removed under reduced pressure. The solid was re-dissolved in EtOAc and washed with H₂O. After drying (Na₂SO₄), the solution was concentrated under reduced pressure. The resulting precipitate was filtered off under vacuum, to afford 1,4-dibromo-2,5-dioctyloxybenzene, as a white crystalline solid. (8.82 g, 59%). ¹H NMR (500 MHz, CDCl₃): δ_{H}7.08 (s, 2H), 3.94 (t, J=6.5 Hz, 4H), 1.80 (dt, J=14.8, 6.6 Hz, 4H), 1.51-1.44 (m, 4H), 1.39-1.23 (m, 16H), 0.89 (t, J=6.8 Hz, 6H). ¹³C NMR (125 MHz, CDCl₃): δ_{C} 150.1, 118.5, 111.2, 70.3, 31.8, 29.2, 26.0, 22.7, 14.1.

1: 1,4-Dioxane (5 mL) and H₂O (5 mL) were mixed and degassed using N₂. A mixture of 1,4-dibromo-2,5-dioctyloxybenzene (80 mg, 0.16 mmol), 4-fluorophenylboronic acid (61 mg, 0.44 mmol), Pd(PPh₃)₄ (27 mg, 0.023 mmol) and Cs₂CO₃ (259 mg, 0.795 mmol) was degassed under vacuum, followed by a N₂ flow cycle repeated three times. The degassed solvent was then injected into this mixture using a cannula. After reacting at 100° C. under N₂ atmosphere in a microwave reactor for 4 h, the mixture was cooled to room temperature and the solvent was removed under reduced pressure. The solid was re-dissolved in CH₂Cl₂ and washed with H₂O. After drying (Na₂SO₄), the solution was mixed with Celite®545 and purified by column chromatography (SiO₂, hexane/EtOAc 49:1) to afford the product 1 as a white solid (77 mg, 91%). ¹H NMR (500 MHz, CDCl₃) δ_{H}: 7.63-7.50 (m, 4H), 7.16-7.06 (m, 4H), 6.94 (s, 2H), 3.90 (t, J=6.4 Hz, 4H), 1.67 (p, J=14.3, 6.5 Hz, 4H), 1.39-1.31 (m, 4H), 1.30-1.19 (m, 16H), 0.88 (t, J=7.0 Hz, 6H). ¹³C NMR (125 MHz, CDCl₃) δ_{C}: 163.2, 161.2, 150.3, 134.4 (two overlapping peaks), 131.3, 131.2, 130.0, 116.3, 115.0, 114.9, 69.8, 31.9, 29.5, 29.4 (two overlapping peaks), 26.2, 22.8, 14.2. MS-APCI(+) (m/z): [M]⁺ calculated for C₃₄H₄₄F₂O₂, 522.3304; found, 522.3311.

2: 1,4-Dioxane (5 mL) and H₂O (5 mL) were mixed and degassed using N₂. A mixture of 1,4-dibromo-2,5-dioctyloxybenzene (63 mg, 0.13 mmol), 4-(trifluoromethyl)phenylboronic acid (76 mg, 0.40 mmol), Pd(PPh₃)₄ (18 mg, 0.016 mmol) and Cs₂CO₃ (207 mg, 0.635 mmol) was degassed under vacuum, followed by a N₂ flow cycle repeated three times. Employing the same procedure as that described in the synthesis of compound 1, the product 2 was obtained as a white solid (72 mg, 90%). ¹H NMR (500 MHz, CDCl₃) δ_{H}: 8.09 (d, J=8.4 Hz, 4H), 7.67 (d, J=8.4 Hz, 4H), 6.99 (s, 2H), 3.95 (s, 6H), 3.92 (t, J=6.4 Hz, 4H), 1.68 (dt, J=14.3, 6.5 Hz, 4H), 1.34 (t, J=10.7 Hz, 4H), 1.25 (dq, J=13.7, 8.4, 7.8 Hz, 16H), 0.87 (t, J=7.0 Hz, 6H). ¹³C NMR (125 MHz, CDCl₃) δ_{C}: 150.4, 130.2, 130.0, 125.0 (two overlapping peaks), 116.1, 69.8, 31.9, 29.4, 29.3, 26.2, 22.8, 14.2. MS-APCI(+) (m/z): [M]⁺ calculated for C₃₆H₄₄F₆O₂, 622.3240; found, 622.3244.

3: 1,4-Dioxane (5 mL) and H₂O (5 mL) were mixed and degassed using N₂. A mixture of 1,4-dibromo-2,5-dioctyloxybenzene (73 mg, 0.15 mmol), 4-cyanophenylboronic acid (63 mg, 0.43 mmol), Pd(PPh₃)₄ (22 mg, 0.019 mmol) and Cs₂CO₃ (224 mg, 0.687 mmol) was degassed under vacuum, followed by a N₂ flow cycle repeated three times. Employing the same procedure as that described in the synthesis of compound 1, the product 3 was obtained as a white solid (74 mg, 92%). ¹H NMR (500 MHz, CDCl₃) δ_{H}: 7.70 (d, J=1.1 Hz, 8H), 6.95 (s, 2H), 3.93 (t, J=6.4 Hz, 4H), 1.68 (p, J=6.5 Hz, 4H), 1.37-1.30 (m, 4H), 1.30-1.18 (m, 16H), 0.88 (t, J=7.1 Hz, 6H). ¹³C NMR (125 MHz, CDCl₃) δ_{C}: 167.3, 150.5, 143.2, 130.5, 129.7, 129.4, 128.8, 116.1, 69.8, 52.2, 31.9, 29.4 (two overlapping peaks), 29.3, 26.2, 22.8, 14.2. MS-APCI(+) (m/z): [M]⁺ calculated for C₃₆H₄₄N₂O₂, 536.3397; found, 536.3394.

4: 1,4-Dioxane (5 mL) and H₂O (5 mL) were mixed and degassed using N₂. A mixture of 1,4-dibromo-2,5-dioctyloxybenzene (77 mg, 0.16 mmol), 4-(methoxycarbonyl)phenylboronic acid (79 mg, 0.44 mmol), Pd(PPh₃)₄ (25 mg, 0.022 mmol) and Cs₂CO₃ (253 mg, 0.777 mmol) was degassed under vacuum, followed by a N₂ flow cycle repeated three times. The degassed solvent was then injected into the mixture. Employing the same procedure as that described in the synthesis of compound 1, the product 4 was obtained as a white solid (88 mg, 94%). ¹H NMR (500 MHz, CDCl₃) δ_{H}: 7.69 (q, J=8.4 Hz, 8H), 6.97 (s, 2H), 3.93 (t, J=6.5 Hz, 4H), 1.68 (dt, J=14.3, 6.5 Hz, 4H), 1.38-1.30 (m, 4H), 1.31-1.20 (m, 16H), 0.87 (t, J=7.1 Hz, 6H). ¹³C NMR (125 MHz, CDCl₃) δ_{C}: 150.4, 143.0, 131.9, 130.3, 130.0, 119.2, 115.8, 110.9, 69.7, 31.9, 29.4, 29.3, 26.2, 22.8, 14.3. MS-ESI(+) (m/z): [M+H]⁺ calculated for C₃₈H₅₁O₆, 603.3680; found, 603.3680; [M+NH₄]⁺ calculated for C₃₈H₅₄NO₆, 620.3946; found, 620.3926; [M+Na]⁺ calculated for C₃₈H₅₀O₆Na, 625.3500; found, 625.3488.

5: 1,4-Dioxane (10 mL) and H₂O (10 mL) were mixed and degassed using N₂. A mixture of 1,4-dibromo-2,5-dioctyloxybenzene (1003 mg, 2.04 mmol), 4-nitrophenylboronic acid (1365 mg, 8.18 mmol), Pd(PPh₃)₄ (397 mg, 0.344 mmol) and Cs₂CO₃ (3.83 g, 11.8 mmol) was degassed under vacuum, followed by a N₂ flow cycle repeated three times and the degassed solvent was injected into this mixture using a cannula. After reacting at 90° C. under N₂ atmosphere for 24 h, the mixture was cooled to room temperature and solvent was removed under reduced pressure. The remaining solid was dissolved in CH₂Cl₂ and mixed with Celite®545 in preparation for purification by column chromatography (SiO₂, hexane/CH₂Cl₂ 9:1) to afford the product 5 as a yellow solid (995 mg, 85%). ¹H NMR (500 MHz, CDCl₃) δ_{H}: 8.26 (d, J=4.4, 1.0 Hz, 4H,), 7.74 (d, J=4.4, 2.0 Hz, 4H), 6.99 (s, 2H), 3.95 (t, J=6.4 Hz, 4H), 1.69 (dt, J=7.2, 3.4 Hz, 4H), 1.39-1.31 (m, 4H), 1.30-1.19 (m, 16H), 0.87 (t, J=7.0 Hz, 6H). ¹³C NMR (125 MHz, CDCl₃): δ_{C}: 150.3, 146.8, 144.8, 130.3, 129.7, 123.3, 115.6, 69.6, 31.8, 29.2 (two overlapping peaks), 26.1, 22.6, 14.1. MS-ESI(+) (m/z): [M+NH₄]⁺ calculated for C₃₄H₄₈N₃O₆, 594.3538; found, 594.3547; [M+Na]⁺ calculated for C₃₄H₄₄N₂O₆Na, 599.3092; found, 599.3102.

6: 1,4-Dioxane (80 mL) and H₂O (80 mL) were mixed and degassed using N₂. A mixture of 1,4-dibromo-2,5-dimethoxybenzene (2.16 g, 7.30 mmol), 4-pyridineboronic acid (1.91 g, 15.5 mmol), Pd(PPh₃)₄ (856 mg, 0.741 mmol) and Cs₂CO₃ (6.04 g, 18.5 mmol) was degassed further using vacuum, followed by a N₂ flow cycle repeated three times and the degassed solvent was injected into this mixture using a cannula. Employing the same procedure as that described in the synthesis of compound 5, the product 6 was obtained as a yellow solid (1988 mg, 93%). ¹H NMR (500 MHz, CDCl₃)_{H} 8.67 (d, J=5.1 Hz, 4H), 7.52 (d, J=5.2 Hz, 4H), 7.00 (s, 2H), 3.83 (s, 6H). ESI-HRMS (m/z): [M+H]⁺ calculated for C₁₈H₁₆N₂O₂, 293.1212; found, 293.1297.

7·2PF₆: A solution of 6 (101 mg, 0.35 mmol) and benzyl bromide (1.0 mL, 4.1 mmol) in a mixture of dry CH₂Cl₂ (20 mL) and MeCN (40 mL) was heated under reflux for 24 h. The precipitate was collected by filtration and washed with CH₂Cl₂ (3×20 mL). The precipitate was dissolved in anhydrous MeOH (100 mL) and the solution filtered, followed by the addition of NH₄PF₆. The resulting precipitate was isolated, washed with H₂O (2×30 mL) and dried in vacuo to obtain the product 7·2PF₆ as a yellow solid (195 mg, 89%). ¹H NMR (500 MHz, CD₃CN) δ_{H}8.74 (d, J=7.0 Hz, 4H), 8.34 (d, J=7.0 Hz, 4H), 7.52 (s, 10H), 7.47 (d, J=8.3 Hz, 4H), 7.33 (s, 2H), 5.75 (s, 4H), 3.93 (s, 6H). ESI-HRMS (m/z): [M−PF₆]⁺ calculated for C₃₂H₃₀F₆N₂O₂P, 619.1944; found, 619.1947.

8·2PF₆: A solution of 6 (590 mg, 1.99 mmol) and p-xylylene dibromide (5.31 g, 20.1 mmol) in a mixture of dry CH₂Cl₂ (100 mL) and MeCN (200 mL) was heated under reflux for 24 h. The precipitate was collected by filtration and washed with CH₂Cl₂ (3×50 mL). The precipitate was then dissolved in anhydrous MeOH (300 mL) and the solution filtered, followed by the addition of NH₄PF₆. The resulting precipitate was isolated, washed with H₂O (2×80 mL) and dried in vacuo to obtain the product 8·2PF₆ as a yellow solid (1.55 g, 82%). ¹H NMR (500 MHz, CD₃CN) δ_{H} 8.75 (d, J=7.0 Hz, 4H), 8.32 (d, J=7.0 Hz, 4H), 7.55 (d, J=8.3 Hz, 4H), 7.47 (d, J=8.3 Hz, 4H), 7.31 (s, 2H), 5.72 (s, 4H), 4.61 (s, 4H), 3.91 (s, 6H). ESI-HRMS (m/z): [M−PF₆]⁺ calculated for C₃₄H₃₂Br₂N₂O₂F₁₂P₂, 805.0446; found, 805.0446.

9·4PF₆: A solution of 6 (80 mg, 0.274 mmol), 8.2PF₆ (260 mg, 0.274 mmol), and TBAI (18 mg, 0.056 mmol) in dry MeCN (200 mL) was heated under reflux for 3 days. After cooling to room temperature, excess of TBACl was added to quench the reaction and the crude precipitate was subjected to reverse-phase C18 column chromatography, starting with H₂O/0.1% TFA as eluent, followed by continuous addition of MeCN up to an eluent mixture of 99.9% MeCN/0.1% TFA. The fractions containing the product were combined and followed by removal of MeCN by rotary evaporation under vacuum. The resulting solid was dissolved in H₂O and treated with an excess of NH₄PF₆, affording a yellow precipitate. which was separated by filtration and dried in vacuo to obtain the product 9·4PF₆ as a yellow solid (124 mg, 33%). ¹H NMR (500 MHz, CD₃CN) δ_{H} 8.78 (d, J=6.3 Hz, 8H), 8.19 (d, J=6.3 Hz, 8H), 7.64 (s, 8H), 7.12 (s, 4H), 5.70 (s, 8H), 3.76 (s, 12H). ¹³C NMR (125 MHz, CD₃CN): δ_{c} 154.9, 152.2, 144.4, 135.4, 130.6, 129.1, 127.5, 115.6, 63.8, 57.0. ESI-HRMS (m/z): [M−2PF₆]²⁺ calculated for C₅₂H₄₈F₁₂N₄O₄P₂, 541.1474; found, 541.1473.

### C. UV/Vis Absorption and Fluorescence Emission Spectroscopic Analyses

Fluorescent dyes were dissolved in the appropriate solvents to afford 1 mM solutions prior to spectroscopic analysis. A portion of 30 μL of a 1 mM solution was diluted by adding a selected solvent to a sample with a total volume of 3000 μL, affording a 1×10⁻⁵ M solution. UV/Vis Absorption spectra were recorded in glass cuvettes on a UV-3600 Shimadzu spectrophotometer. Steady-state emission spectra were acquired in quartz cuvettes with optical path-lengths of 10 mm containing the solution being analyzed using a HORIBA Fluoromax4 spectrofluorometer, which was equipped with an integrating sphere for determining the absolute photoluminescence quantum yield.

Steady-state and time-resolved emission spectra for dyes 7·2PF₆ and 9·4PF₆ were acquired using a HORIBA Fluorolog-3 spectrofluorometer, equipped with a time-correlated single photon counting (TCSPC) module (diode laser excitation at =375 nm) and an integrating sphere, which was used for absolute photo-luminescence quantum yield determinations. Picosecond time-resolved fluorescence measurements were recorded using a commercial direct-diode-pumped 100 kHz amplifier (Spirit 1040-HE, Spectra-Physics), producing a fundamental beam of 1040 nm (350 fs, 12 W) which was used to pump a non-collinear optical parametric amplifier (Spirit-NOPA, SpectraPhysics) capable of delivering tunable, high-repetition-rate pulses with pulse widths as short as sub-20 fs. The samples 7·2PF₆ and 9·4PF₆ were excited with 340 nm, 2 nJ laser pulses. Fluorescence was detected using a Hamamatsu C4780 Streakscope as previously described in the literature.⁷¹ Samples were prepared in 2-mm quartz cuvettes. All data were acquired in the single-photon-counting mode using the Hamamatsu HPD-TA software. The temporal resolution was approximately 2% of the sweep window. Single wavelength kinetic analysis was performed using a nonlinear least-squares fit to a sum of exponentials convoluted with an instrument response function. Visible and near-infrared femtosecond and nanosecond transient absorption (fsTA and nsTA, respectively) spectroscopies were performed following descriptions already recorded in the literature.⁵⁸ The 330 nm, ˜100 fs pump pulses were generated at 1 μJ per pulse using a commercial collinear optical parametric amplifier (TOPAS-Prime, Light-Conversion, Ltd.); 414-nm pump pulses were obtained by second-harmonic generation of the 828 nm fundamental. The pump polarization was randomized using a commercial depolarizer (DPU-25-A, Thorlabs, Inc.) to eliminate any orientational dynamics resulting from the experiment. Spectra were collected on commercial spectrometers (customized Ultrafast Systems Helios and EOS spectrometers, for fsTA and nsTA, respectively) for each time window. All samples were stirred to avoid localized heating or degradation effects. The optical density was maintained at 0.6 for all samples.

### D. X-Ray Crystallography

X-Ray quality single-crystals of dyes 1-5 were obtained by slow evaporation of CH₂Cl₂ solutions left open to the air at 298 K. The tetrakis(hexaflurophosphate) salt of the tetracationic cyclophane 9⁴⁺ was dissolved in MeCN at 298 K and the mixture was passed through a 0.45 m filter separately into three 1-mL tubes. The tubes were placed together in a 20-mL vial containing ⁱPr₂O (˜3 mL) and the vial was capped. Slow vapor diffusion of ⁱPr₂O into the solution of 9·4PF₆ in MeCN over the course of a week yielded yellow single crystals. A suitable crystal was selected and it was mounted on a MITIGEN holder with Paratone oil on (i) a XtaLAB Synergy R, DW system, HyPix or (ii) a Bruker and APEX-II CCD diffractometer.

### E. Cell Culture, Treatment and Imaging

MCF-7 Breast cancer cells were grown in standard Dulbecco's modified eagle medium (DMEM), which was supplemented with 10% Fetal Bovine Serum (FBS) and 1% Penicillin-Streptomycin (Corning). Cells were seeded into an 8-well imaging coverglass chamber (manufacturer-CellVis) or multiwell plate using phenol red free DMEM about 24 h prior to treatment. Dye 9·4Cl was resuspended in deionized H₂O before being diluted to their final concentrations in the cell culture media. Cells were treated with the dye for 24 h prior to imaging. Uptake assays were carried out at concentrations from 1-50 μM, including a vehicle control (untreated). For the cell growth assays, cells were treated with the dye for 24 h at a range of concentrations from 0.1-50 μM.

Confocal imaging was performed on a Leica SP8 laser scanning confocal microscope on a DMi8 upright stand with LAS X software in the Biological Imaging Facility (BIF) at Northwestern University. Uptake images were taken with a 63×/1.4 NA objective, scanning at a zoom of two with a pinhole of one Airy unit (AU) at 600 Hz with a galvo scanner and line averaging of two. Images were 92.35×92.35 μm (1024×1024) with 10 slices in the z direction with a step size of 0.3 μm (total stack volume 3.0 μm). A single excitation wavelength (405 nm) was used at a power of approximately 14 μW. For the emission collection, a Leica spectral Hybrid (HyD) detector set to collect a wavelength range of 500-650 nm (with a gain of 24%) was used. A transmitted light image was also collected simultaneously using the timeline photomultiplier (TL-PMT). Images were processed with FIJI/ImageJ (NIH) and settings were kept consistent throughout the series of images. Images presented are maximum intensity projections.

For the cell cytotoxicity experiments, MCF-7 cells were plated in a 96-well culture plate at a density of 0.01×10⁶ cells per well in DMEM media with 10% FBS and 1% Penicillin-Streptomycin. Cells were cultured for 24 h before being treated with the dye at a range of concentrations from 0.1-50 μM. After treatment, cells were placed in a BioTek LionheartFX system, where they were imaged at 4× magnification every 3 h for 72 h under standard (37° C., 5% CO₂) culture conditions. Phase contrast images were processed and analyzed with BioTek Gen5 analysis software to identify cell numbers at each time point during the culture period.

### F. Crystallization Protocols

### Crystal Structure of 1

(a) Method: 1 was dissolved in CH₂Cl₂ and the solvent was left to evaporate in air. A suitable single crystal was selected, and it was mounted on a MITIGEN holder with Paratone oil on a XtaLAB Synergy R, DW system, HyPix diffractometer. The crystal was kept at 99.9 K during data collection. Using Olex2, the structure was solved with the ShelXT structure solution program using Intrinsic Phasing and refined with the XL refinement package using Least Squares minimization.
(b) Crystal Parameters: Empirical formula=C₃₄H₄₄F₂O₂, formula weight=522.69: triclinic, space group P1̅ (no. 2), a=9.62170(10), b=19.1864(3), c=25.0861(4) Å, α=97.5360(10), β=96.9030(10), γ=100.1120(10)°, V=4470.80(11) Å³, Z=6, T=99.9(3) K, μ(CuKα)=0.629 mm⁻¹, Dcalc=1.165 g/mm³, 61158 reflections measured (3.592≤2Θ≤153.422), 18026 unique (Rᵢₙₜ=0.0371, R_{sigma}=0.0406) which were used in all calculations. The final R₁ was 0.0590 (I>2σ(I)) and wR₂ was 0.1782 (all data).
(c) Refinement Details: No special refinement necessary.
(d) Solvent Treatment Details: N/A

### Crystal Structure of 2

(a) Method: 2 was dissolved in CH₂Cl₂ and the solvent was left to evaporate in air. A suitable single crystal was selected, and it was mounted on a MITIGEN holder with Paratone oil on a XtaLAB Synergy R, DW system, HyPix diffractometer. The crystal was kept at 99.99 K during data collection. Using Olex2, the structure was solved with the ShelXT structure solution program using Intrinsic Phasing and refined with the XL refinement package using Least Squares minimization.
(b) Crystal Parameters: Empirical formula=C₃₆H₄₄F₆O₂, formula weight=622.71: triclinic, space group P1̅ (no. 2), a=10.4962(3), b=11.5029(5), c=13.7036(4) Å, α=93.913(3), β=91.372(3), γ=100.770(3)°, V=1620.46(10) Å³, Z=2, T=99.99(10) K, μ(CuKα)=0.847 mm⁻¹, Dcalc=1.276 g/mm³, 20252 reflections measured (6.47≤2Θ≤161.366), 6601 unique (Rᵢₙₜ=0.0457, R_{sigma}=0.0462) which were used in all calculations. The final R₁ was 0.0588 (I>2σ(I)) and wR₂ was 0.1764 (all data).
(c) Refinement Details: No special refinement necessary.
(d) Solvent Treatment Details: N/A

### Crystal Structure of 3

(a) Method: 3 was dissolved in CH₂Cl₂ and the solvent was left to evaporate in air. A suitable single crystal was selected, and it was mounted on a MITIGEN holder with Paratone oil on a XtaLAB Synergy R, DW system, HyPix diffractometer. The crystal was kept at 100.00 K during data collection. Using Olex2, the structure was solved with the ShelXT structure solution program using Intrinsic Phasing and refined with the XL refinement package using Least Squares minimization.
(b) Crystal Parameters: Empirical formula=C₃₄H₄₄N₂O₂, formula weight=536.73: monoclinic, space group P2₁/c (no. 14), a=15.9753(3), b=5.11836(11), c=19.1132(4) Å, β=98.3301(17)°, V=1546.35(5) Å³, Z=2, T=100.00(10) K, μ(CuKα)=0.546 mm⁻¹, Dcalc=1.153 g/mm³, 26023 reflections measured (5.592≤2Θ≤156.882), 3220 unique (Rᵢₙₜ=0.0471, R_{sigma}=0.0260) which were used in all calculations. The final R₁ was 0.0388 (I>2σ(I)) and wR₂ was 0.1100 (all data).
(c) Refinement Details: No special refinement necessary.
(d) Solvent Treatment Details: N/A

### Crystal Structure of 4

(a) Method: 4 was dissolved in CH₂Cl₂ and the solvent was left to evaporate rated in air. A suitable single crystal was selected, and it was mounted on a MITIGEN holder with Paratone oil on a XtaLAB Synergy R, DW system, HyPix diffractometer. The crystal was kept at 99.96 K during data collection. Using Olex2, the structure was solved with the ShelXT structure solution program using Intrinsic Phasing and refined with the XL refinement package using Least Squares minimization.
(b) Crystal Parameters: Empirical formula=C₃₈H₅₀O₆, formula weight=602.78: triclinic, space group P1̅ (no. 2), a=6.1818(3), b=11.6153(4), c=12.3302(4) Å, α=102.839(3), β=103.664(4), γ=96.008(3)°, V=827.16(6) Å³, Z=1, T=99.96(11) K, μ(CuKα)=0.637 mm⁻¹, Dcalc=1.210 g/mm³, 15297 reflections measured (7.632≤2Θ≤157.686), 3389 unique (Rᵢₙₜ=0.0506, R_{sigma}=0.0297) which were used in all calculations. The final R₁ was 0.0446 (I>2σ(I)) and wR₂ was 0.1338 (all data).
(c) Refinement Details: No special refinement necessary.
(d) Solvent Treatment Details: N/A

### Crystal Structure of 5

(a) Method: 5 was dissolved in CH₂Cl₂ and the solvent was left to evaporate in air. A suitable single crystal was selected, and it was mounted on a MITIGEN holder with Paratone oil on a Bruker APEX-II CCD diffractometer. The crystal was kept at 99.98 K during data collection. Using Olex2, the structure was solved with the ShelXT structure solution program using Intrinsic Phasing and refined with the XL refinement package using Least Squares minimization.
(b) Crystal Parameters: Empirical formula=C₃₄H₄₄N₂O₆, formula weight=576.71 monoclinic, space group P2₁/c (no. 14), a=17.536(3), b=3.9860(6), c=21.963(3) Å, β=93.557(10)°, V=1532.2(4) Å³, Z=2, T=99.98 K, μ(CuKα)=0.686 mm⁻¹, Dcalc=1.250 g/mm³, 6659 reflections measured (8.066≤2Θ≤133.374), 2675 unique (Rᵢₙₜ=0.0323, R_{sigma}=0.0389) which were used in all calculations. The final R₁ was 0.0368 (I>2σ(I)) and wR₂ was 0.0990 (all data).
(c) Refinement Details: No special refinement necessary.
(d) Solvent Treatment Details: N/A

### Crystal Structure of 9·4PF₆

(a) Methods: 9·4PF₆ was dissolved in MeCN at 298 K and the mixture was passed through a 0.45 m filter equally into three 1-mL tubes. The tubes were placed together in one 20-mL vial containing ⁱPr₂O (˜3 mL) and the vial was capped. Slow vapor diffusion of ⁱPr₂O into the solution of 9·4PF₆ in MeCN over the course of one week yielded yellow single crystals of 9·4PF₆. Data were collected at 100 K on a Bruker Kappa APEX CCD Diffractometer equipped with a CuKα microsource with Quazar optics.
(b) Crystal Parameters: [C₅₂H₄₈N₄O₄·(PF₆)₄]·(MeCN)₆ (M=1619.14): triclinic, space group P1̅ (no. 2), a=10.0220(3), b=11.1792(3), c=17.8291(5) Å, α=105.518(2), β=105.449(2), γ=96.000(2)°, V=1821.64(9) Å³, Z=1, T=100.00(10) K, μ(MoKα)=0.218 mm⁻¹, Dcalc=1.476 g/mm³, 33554 reflections measured (3.888≤2Θ≤67.054), 12174 unique (Rᵢₙₜ=0.0345, R_{sigma}=0.0462) which were used in all calculations. The final R₁ was 0.0526 (I>2σ(I)) and wR₂ was 0.1630 (all data).
(c) Refinement Details: No special refinement necessary.
(d) Solvent Treatment Details: N/A

### G. DFT Calculations

All calculations were performed using Gaussian16 with the Austin-Frisch-Peterson (APFD) functional and the 6-31G(d) basis set. Input geometries for all calculations were constructed from the coordinates acquired from single crystal structures of the dyes, with the exception of the dye 4, which had a crystal packing geometry that deviated from the aggregation geometry that would be expected from that observed in solution. Frequency calculations were used at the same level of theory to validate all located stationary points, ensuring that there were no negative frequencies for minima. TD-DFT calculations were performed at the same level of theory. In order to insure that our choice of basis set was sufficient, TD-DFT calculations were repeated for the monomer representations of the dyes and a representative dimer (5) using the larger 6-311+G(2d,p) basis set. Under this larger, more computationally expensive basis set, no appreciable difference was observed for the predicted spectra compared to that obtained using the 6-31G(d) basis set.

In the dimers of dyes 1 and 3-5, each of the terminal EWG-substituted rings have a close to coplanar conformation. This geometry is indicated in Table S3 by showing a pair of opposite (±) dihedral angles between adjacent rings. In the dimer of dye 2, however, the occurrence of only positive (+) dihedral angles, resulting from the CF₃ groups, leads to a unique non-coplanar conformation of the terminal CF₃-substituted rings. As a result of this different conformation, the dimer of dye 2 has a smaller energy gap between the LUMO and LUMO+1 (ΔE=0.05 eV) compared to the gaps (ΔE=0.11-0.15 eV) in the other dyes. It is hypothesized that these differences in energy gaps are the reasons that its S1 excitation accesses the LUMO+1 orbital, whereas S1 excitations in other dyes are constituted almost entirely of HOMO to LUMO transitions.

In order to visualize the interactions between the minimized structures of the dimers of dyes 1-5, the independent gradient model based on the Hirshfeld partition of molecular density (IGMH) method was used. This computational method plots a surface representing noncovalent interactions between weakly interacting compounds. The IGMH plots confirm that the spatial pattern of interactions between the EWG-substituted para-terphenylene backbones depends on the relative orientation and position of the aromatic rings. The visualizations were performed considering only the substituted anthracene cores of the dimers. IGMH Analyses were performed using the multiWFN software and visualized using the VMD software.

### REFERENCES

1. Li, D.; Guo, C.; Zhang, X.; Du, B.; Wang, P.; Cheng, S.; Cai, J.; Wang, H.; Liu, D.; Yao, H.; Hou, J.; Wang, T. Heating-Induced Aggregation Control for Efficient Sequential-Cast Organic Solar Cells. Aggregate 2022, 3, e104.
2. Mata, G.; Luedtke, N. W. Synthesis and Solvatochromic Fluorescence of Biaryl Pyrimidine Nucleosides. Org. Lett. 2013, 15, 2462-2465.
3. Klymchenko, A. S.; Mely, Y. Chapter Two—Fluorescent Environment-Sensitive Dyes as Reporters of Biomolecular Interactions. Prog. Mol. Biol. Transl. Sci. 2013, 113, 35-58.
4. Cornec, A.-S.; Baudequin, C.; Fiol-Petit, C.; Ple, N.; Dupas, G.; Ramondenc, Y. One “Click” to Access Push-Triazole-Pull Fluorophores Incorporating a Pyrimidine Moiety: Structure-Photophysical Properties Relationships. Eur. J. Org. Chem. 2013, 2013, 1908-1915.
5. Jacquart, A.; Williams, R. M.; Brouwer, A. M.; Ishow, E. Decoupling Fluorescence and Photochromism in Bifunctional Azo Derivatives for Bulk Emissive Structures. Chem. Eur. J. 2012, 18, 3706-3720.
6. Dong, Y.; Bolduc, A.; McGregor, N.; Skene, W. G. Push-Pull Aminobithiophenes Highly Fluorescent Stable Fluorophores. Org. Lett. 2011, 13, 1844-1847.
7. Loving, G. S.; Sainlos, M.; Imperiali, B. Monitoring Protein Interactions and Dynamics with Solvatochromic Fluorophores. Trends. Biotechnol. 2010, 28, 73-83.
8. Qian, X.; Xiao, Y. 4-Amino-1,8-dicyanonaphthalene Derivatives as Novel Fluorophore and Fluorescence Switches: Efficient Synthesis and Fluorescence Enhancement Induced by Transition Metal Ions and Protons. Tetrahedron Lett. 2002, 43, 2991-2994.
9. Ventelon, L.; Blanchard-Desce, M.; Moreaux, L.; Mertz, J. New Quadrupolar Fluorophores with High Two-Photon Excited Fluorescence. Chem. Commun. 1999, 2055-2056.
10. Hardin, B. E.; Snaith, H. J.; McGehee, M. D. The Renaissance of Dye-Sensitized Solar Cells. Nat. Photonics 2012, 6, 162-169.
11. Mishra, A.; Fischer, M. K. R.; Bauerle, P. Metal-Free Organic Dyes for Dye-Sensitized Solar Cells: From Structure: Property Relationships to Design Rules. Angew. Chem. Int. Ed. 2009, 48, 2474-2499.
12. Ning, Z.; Tian, H. Triarylamine: A Promising Core Unit for Efficient Photovoltaic Materials. Chem. Commun. 2009, 5483-5495.
13. Huang, C.; Sartin, M. M.; Siegel, N.; Cozzuol, M.; Zhang, Y.; Hales, J. M.; Barlow, S.; Perry, J. W.; Marder, S. R. Photo-Induced Charge Transfer and Nonlinear Absorption in Dyads Composed of a Two-Photon-Absorbing Donor and a Perylene Diimide Acceptor. J. Mater. Chem. 2011, 21, 16119-16128.
14. Kim, K. S.; Noh, S. B.; Katsuda, T.; Ito, S.; Osuka, A.; Kim, D. Charge Transfer Induced Enhancement of Near-IR Two-Photon Absorption of 5,15-Bis(azulenylethynyl) Zinc(II) Porphyrins. Chem. Commun. 2007, 2479-2481.
15. Min, H.; Park, I. S.; Yasuda, T. Dipolar and Quadrupolar Luminophores Based on 1,8-Dimethylcarbazole-Triazine Conjugates for High-Efficiency Blue Thermally Activated Delayed Fluorescence OLEDs. ChemPhotoChem 2020, 4, 82-88.
16. Mukhopadhyay, S.; Topham, B. J.; Soos, Z. G.; Ramasesha, S., Neutral and Charged Excited States in Polar Organic Films: Origin of Unusual Electroluminescence in Tri-p-tolylamine-Based Hole Conductors. J. Phys. Chem. A 2008, 112, 7271-7279.
17. Soos, Z. G.; Mukhopadhyay, S.; Ramasesha, S. Polar Organic Films: Transport Gap, Charge-Dipole Interaction and Electroluminescence of Tritolylamine (TTA) Derivatives. Chem. Phys. Lett. 2007, 442, 285-288.
18. Shirota, Y. Photo- and Electroactive Amorphous Molecular Materials-Molecular Design, Syntheses, Reactions, Properties, and Applications. J. Mater. Chem. 2005, 15, 75-93.
19. Ooyama, Y.; Matsugasako, A.; Oka, K.; Nagano, T.; Sumomogi, M.; Komaguchi, K.; Imae, I.; Harima, Y. Fluorescence PET (Photo-Induced Electron Transfer) Sensors for Water Based on Anthracene-Boronic Acid Ester. Chem. Commun. 2011, 47, 4448-4450.
20. de Silva, A. P.; Moody, T. S.; Wright, G. D. Fluorescent PET (Photoinduced Electron Transfer) Sensors as Potent Analytical Tools. Analyst 2009, 134, 2385-2393.
21. Griesbeck, S.; Michail, E.; Rauch, F.; Ogasawara, H.; Wang, C.; Sato, Y.; Edkins, R. M.; Zhang, Z.; Taki, M.; Lambert, C.; Yamaguchi, S.; Marder, T. B. The Effect of Branching on One- and Two-Photon Absorption, Cell Viability and Localization of Cationic Triarylborane Chromophores with Dipolar vs. Octupolar Charge Distributions for Cellular Imaging. Chem. Eur. J. 2019, 25, 13164-13175.
22. Didier, P.; Ulrich, G.; Mely, Y.; Ziessel, R. Improved Push-Pull-Push E-Bodipy Fluorophores for Two-Photon Cell-Imaging. Org. Biomol. Chem. 2009, 7, 3639-3642.
23. Lord, S. J.; Conley, N. R.; Lee, H.-l. D.; Nishimura, S. Y.; Pomerantz, A. K.; Willets, K. A.; Lu, Z.; Wang, H.; Liu, N.; Samuel, R.; Weber, R.; Semyonov, A.; He, M.; Twieg, R. J.; Moerner, W. E. DCDHF Fluorophores for Single-Molecule Imaging in Cells. ChemPhysChem 2009, 10, 55-65.
24. Lord, S. J.; Conley, N. R.; Lee, H.-L. D.; Samuel, R.; Liu, N.; Twieg, R. J.; Moerner, W. E. A Photoactivatable Push-Pull Fluorophore for Single-Molecule Imaging in Live Cells. J. Am. Chem. Soc. 2008, 130, 9204-9205.
25. Chen, X.-Y.; Liu, Z.-Q.; Zhao, C.-H. Two-Photon Excited Fluorescent 3,3′-Diamino-5,5′-Diboryl-2,2′-Bithienyls Featuring a Quadrupolar Structure. Chem. Eur. J. 2022, 28, e202104432.
26. Berger, S. M.; Marder, T. B. Applications of Triarylborane Materials in Cell Imaging and Sensing of Bio-relevant Molecules such as DNA, RNA, and Proteins. Mater. Horiz. 2022, 9, 112-120.
27. Berger, S. M.; Rühe, J.; Schwarzmann, J.; Phillipps, A.; Richard, A.-K.; Ferger, M.; Krummenacher, I.; Tumir, L.-M.; Ban, Ž.; Crnolatac, I.; Majhen, D.; Barišić, I.; Piantanida, I.; Schleier, D.; Griesbeck, S.; Friedrich, A.; Braunschweig, H.; Marder, T. B. Bithiophene-Cored, mono-, bis-, and tris-(Trimethylammonium)-Substituted, bis-Triarylborane Chromophores: Effect of the Number and Position of Charges on Cell Imaging and DNA/RNA Sensing. Chem. Eur. J. 2021, 27, 14057-14072.
28. Griesbeck, S.; Michail, E.; Wang, C.; Ogasawara, H.; Lorenzen, S.; Gerstner, L.; Zang, T.; Nitsch, J.; Sato, Y.; Bertermann, R.; Taki, M.; Lambert, C.; Yamaguchi, S.; Marder, T. B. Tuning the π-Bridge of Quadrupolar Triarylborane Chromophores for One- and Two-Photon Excited Fluorescence Imaging of Lysosomes in Live Cells. Chem. Sci. 2019, 10, 5405-5422.
29. Rout, Y.; Montanari, C.; Pasciucco, E.; Misra, R.; Carlotti, B. Tuning the Fluorescence and the Intramolecular Charge Transfer of Phenothiazine Dipolar and Quadrupolar Derivatives by Oxygen Functionalization. J. Am. Chem. Soc. 2021, 143, 9933-9943.
30. Ban, Ž.; Griesbeck, S.; Tomić, S.; Nitsch, J.; Marder, T. B.; Piantanida, I., A Quadrupolar Bis-Triarylborane Chromophore as a Fluorimetric and Chirooptic Probe for Simultaneous and Selective Sensing of DNA, RNA and Proteins. Chem. Eur. J. 2020, 26, 2195-2203.
31. Szakacs, Z.; Tasior, M.; Gryko, D. T.; Vauthey, E. Change of Quadrupole Moment upon Excitation and Symmetry Breaking in Multibranched Donor-Acceptor Dyes. ChemPhysChem 2020, 21, 1718-1730.
32. Dereka, B.; Svechkarev, D.; Rosspeintner, A.; Aster, A.; Lunzer, M.; Liska, R.; Mohs, A. M.; Vauthey, E. Solvent Tuning of Photochemistry Upon Excited-State Symmetry Breaking. Nat. Commun. 2020, 11, 1925.
33. Ferger, M.; Ban, Ž.; Krošl, I.; Tomić, S.; Dietrich, L.; Lorenzen, S.; Rauch, F.; Sieh, D.; Friedrich, A.; Griesbeck, S.; Kenèl, A.; Miljanić, S.; Piantanida, I.; Marder, T. B. Bis(phenylethynyl)arene Linkers in Tetracationic bis-Triarylborane Chromophores Control Fluorimetric and Raman Sensing of Various DNA and RNA. Chem. Eur. J. 2021, 27, 5142-5159.
34. Amini, H.; Ban, Ž.; Ferger, M.; Lorenzen, S.; Rauch, F.; Friedrich, A.; Crnolatac, I.; [symbol] , A.; Miljanić, S.; Piantanida, I.; Marder, T. B. Tetracationic Bis-triarylborane 1,3-Butadiyne as a Combined Fluorimetric and Raman Probe for Simultaneous and Selective Sensing of Various DNA, RNA and Proteins. Chem. Eur. J. 2020, 26, 6017-6028.
35. Griesbeck, S.; Zhang, Z.; Gutmann, M.; Luhmann, T.; Edkins, R. M.; Clermont, G.; Lazar, A. N.; Haehnel, M.; Edkins, K.; Eichhorn, A.; Blanchard-Desce, M.; Meinel, L.; Marder, T. B. Water-Soluble Triarylborane Chromophores for One- and Two-Photon Excited Fluorescence Imaging of Mitochondria in Cells. Chem. Eur. J. 2016, 22, 14701-14706.
36. Soderberg, M.; Dereka, B.; Marrocchi, A.; Carlotti, B.; Vauthey, E. Ground-State Structural Disorder and Excited-State Symmetry Breaking in a Quadrupolar Molecule. J. Phys. Chem. Lett. 2019, 10, 2944-2948.
37. Dereka, B.; Vauthey, E. Direct Local Solvent Probing by Transient Infrared Spectroscopy Reveals the Mechanism of Hydrogen-Bond Induced Nonradiative Deactivation. Chem. Sci. 2017, 8, 5057-5066.
38. Dereka, B.; Rosspeintner, A.; Stezycki, R.; Ruckebusch, C.; Gryko, D. T.; Vauthey, E. Excited-State Symmetry Breaking in a Quadrupolar Molecule Visualized in Time and Space. J. Phys. Chem. Lett. 2017, 8, 6029-6034.
39. Dereka, B.; Koch, M.; Vauthey, E. Looking at Photoinduced Charge Transfer Processes in the IR: Answers to Several Long-Standing Questions. Acc. Chem. Res. 2017, 50, 426-434.
40. Susumu, K.; Fisher, J. A. N.; Zheng, J.; Beratan, D. N.; Yodh, A. G.; Therien, M. J. Two-Photon Absorption Properties of Proquinoidal D-A-D and A-D-A Quadrupolar Chromophores. J. Phys. Chem. A 2011, 115, 5525-5539.
41. Sissa, C.; Terenziani, F.; Painelli, A.; Abbotto, A.; Bellotto, L.; Marinzi, C.; Garbin, E.; Ferrante, C.; Bozio, R. Dimers of Quadrupolar Chromophores in Solution: Electrostatic Interactions and Optical Spectra. J. Phys. Chem. B 2010, 114, 882-893.
42. Terenziani, F.; Painelli, A.; Katan, C.; Charlot, M.; Blanchard-Desce, M. Charge Instability in Quadrupolar Chromophores: Symmetry Breaking and Solvatochromism. J. Am. Chem. Soc. 2006, 128, 15742-15755.
43. Antipov, I. F.; Ivanov, A. I. Effect of Symmetry Breaking in Excited Quadrupole Molecules on Transition Dipole Moment. J. Phys. Chem. B 2021, 125, 13778-13788.
44. Zhang, W.; Xu, W.; Zhang, G.; Kong, J.; Niu, X.; Chan, J. M. W.; Liu, W.; Xia, A. Direct Tracking Excited-State Intramolecular Charge Redistribution of Acceptor-Donor-Acceptor Molecule by Means of Femtosecond Stimulated Raman Spectroscopy. J. Phys. Chem. B 2021, 125, 4456-4464.
45. Chung, H. Y.; Oh, J.; Park, J.-H.; Cho, I.; Yoon, W. S.; Kwon, J. E.; Kim, D.; Park, S. Y. Spectroscopic Studies on Intramolecular Charge-Transfer Characteristics in Small-Molecule Organic Solar Cell Donors: A Case Study on ADA and DAD Triad Donors. J. Phys. Chem. C 2020,124, 18502-18512.
46. Ricci, F.; Carlotti, B.; Keller, B.; Bonaccorso, C.; Fortuna, C. G.; Goodson, T.; Elisei, F.; Spalletti, A. Enhancement of Two-Photon Absorption Parallels Intramolecular Charge-Transfer Efficiency in Quadrupolar versus Dipolar Cationic Chromophores. J. Phys. Chem. C 2017, 121, 3987-4001.
47. Woo, H. Y.; Liu, B.; Kohler, B.; Korystov, D.; Mikhailovsky, A.; Bazan, G. C. Solvent Effects on the Two-Photon Absorption of Distyrylbenzene Chromophores. J. Am. Chem. Soc. 2005, 127, 14721-14729.
48. Le Droumaguet, C.; Mongin, O.; Werts, M. H. V.; Blanchard-Desce, M. Towards “Smart” Multiphoton Fluorophores: Strongly Solvatochromic Probes for Two-Photon Sensing of Micropolarity. Chem. Commun. 2005, 2802-2804.
49. Wu, C.-J. J.; Xue, C.; Kuo, Y.-M.; Luo, F.-T. Preparation and Photoluminescence of p-Terphenyl Derivatives Containing Cyano Groups. Tetrahedron 2005, 61, 4735-4741.
50. Kole, G. K.; Košćak, M.; Amar, A.; Majhen, D.; Božinović, K.; Brkljaca, Z.; Ferger, M.; Michail, E.; Lorenzen, S.; Friedrich, A.; Krummenacher, I.; Moos, M.; Braunschweig, H.; Boucekkine, A.; Lambert, C.; Halet, J.-F.; Piantanida, I.; Müller-Buschbaum, K.; Marder, T. B. Methyl Viologens of Bis-(4′-pyridylethynyl)arenes-Structures, Photophysical and Electrochemical Studies, and their Potential Application in Biology. Chem. Eur. J. 2022, 28, e202200753.
51. Fudickar, W.; Bauch, M.; Ihmels, H.; Linker, T. DNA-Triggered Enhancement of Singlet Oxygen Production by Pyridinium Alkynylanthracenes. Chem. Eur. J. 2021, 27, 13591-13604.
52. Kole, G. K.; Merz, J.; Amar, A.; Fontaine, B.; Boucekkine, A.; Nitsch, J.; Lorenzen, S.; Friedrich, A.; Krummenacher, I.; Košćak, M.; Braunschweig, H.; Piantanida, I.; Halet, J.-F.; Müller-Buschbaum, K.; Marder, T. B. 2- and 2,7-Substituted para-N-Methylpyridinium Pyrenes: Syntheses, Molecular and Electronic Structures, Photophysical, Electrochemical, and Spectroelectrochemical Properties and Binding to Double Stranded (ds)-DNA. Chem. Eur. J. 2021, 27, 2837-2853.
53. Ye, Z.; Yang, W.; Wang, C.; Zheng, Y.; Chi, W.; Liu, X.; Huang, Z.; Li, X.; Xiao, Y. Quaternary Piperazine-Substituted Rhodamines with Enhanced Brightness for Super-Resolution Imaging. J. Am. Chem. Soc. 2019, 141, 14491-14495.
54. Pun, A. B.; Campos, L. M.; Congreve, D. N. Tunable Emission from Triplet Fusion Upconversion in Diketopyrrolopyrroles. J. Am. Chem. Soc. 2019, 141, 3777-3781.
55. Goujon, A.; Colom, A.; Strakova, K.; Mercier, V.; Mahecic, D.; Manley, S.; Sakai, N.; Roux, A.; Matile, S. Mechanosensitive Fluorescent Probes to Image Membrane Tension in Mitochondria, Endoplasmic Reticulum, and Lysosomes. J. Am. Chem. Soc. 2019, 141, 3380-3384.
56. Signorini, R.; Ferrante, C.; Pedron, D.; Zerbetto, M.; Cecchetto, E.; Slaviero, M.; Fortunati, I.; Collini, E.; Bozio, R.; Abbotto, A.; Beverina, L.; Pagani, G. A. Effective Two-Photon Absorption Cross Section of Heteroaromatic Quadrupolar Dyes: Dependence on Measurement Technique and Laser Pulse Characteristics. J. Phys. Chem. A 2008, 112, 4224-4234.
57. Abbotto, A.; Beverina, L.; Bozio, R.; Facchetti, A.; Ferrante, C.; Pagani, G. A.; Pedron, D.; Signorini, R. Novel Heterocycle-Based Two-Photon Absorbing Dyes. Org. Lett. 2002, 4, 1495-1498.
58. Young, R. M.; Dyar, S. M.; Barnes, J. C.; Juríček, M.; Stoddart, J. F.; Co, D. T.; Wasielewski, M. R. Ultrafast Conformational Dynamics of Electron Transfer in ExBox⁴⁺⊂Perylene. J. Phys. Chem. A 2013, 117, 12438-12448.
59. Dyar, S. M.; Barnes, J. C.; Juríček, M.; Stoddart, J. F.; Co, D. T.; Young, R. M.; Wasielewski, M. R. Electron Transfer and Multi-Electron Accumulation in ExBox⁴⁺. Angew. Chem. Int. Ed. 2014, 53, 5371-5375.
60. Dale, E. J.; Vermeulen, N. A.; Juríček, M.; Barnes, J. C.; Young, R. M.; Wasielewski, M. R.; Stoddart, J. F. Supramolecular Explorations: Exhibiting the Extent of Extended Cationic Cyclophanes. Acc. Chem. Res. 2016, 49, 262-273.
61. Ryan, S. T. J.; Young, R. M.; Henkelis, J. J.; Hafezi, N.; Vermeulen, N. A.; Hennig, A.; Dale, E. J.; Wu, Y.; Krzyaniak, M. D.; Fox, A.; Nau, W. M.; Wasielewski, M. R.; Stoddart, J. F.; Scherman, O. A. Energy and Electron Transfer Dynamics within a Series of Perylene Diimide/Cyclophane Systems. J. Am. Chem. Soc. 2015, 137, 15299-15307.
62. Gong, X.; Young, R. M.; Hartlieb, K. J.; Miller, C.; Wu, Y.; Xiao, H.; Li, P.; Hafezi, N.; Zhou, J.; Ma, L.; Cheng, T.; Goddard, W. A.; Farha, O. K.; Hupp, J. T.; Wasielewski, M. R.; Stoddart, J. F. Intramolecular Energy and Electron Transfer within a Diazaperopyrenium-Based Cyclophane. J. Am. Chem. Soc. 2017, 139, 4107-4116.
63. Roy, I.; David, A. H. G.; Das, P. J.; Pe, D. J.; Stoddart, J. F. Fluorescent Cyclophanes and their Applications. Chem. Soc. Rev. 2022, 51, 5557-5605.
64. Roy, I.; Bobbala, S.; Zhou, J.; Nguyen, M. T.; Nalluri, S. K. M.; Wu, Y.; Ferris, D. P.; Scott, E. A.; Wasielewski, M. R.; Stoddart, J. F. ExTzBox: A Glowing Cyclophane for Live-Cell Imaging. J. Am. Chem. Soc. 2018, 140, 7206-7212.
65. Liu, W.; Tan, Y.; Jones, L. O.; Song, B.; Guo, Q.-H.; Zhang, L.; Qiu, Y.; Feng, Y.; Chen, X.-Y.; Schatz, G. C.; Stoddart, J. F. PCage: Fluorescent Molecular Temples for Binding Sugars in Water. J. Am. Chem. Soc. 2021, 143, 15688-15700.
66. Liu, W.; Bobbala, S.; Stern, C. L.; Hornick, J. E.; Liu, Y.; Enciso, A. E.; Scott, E. A.; Stoddart, J. F. XCage: A Tricyclic Octacationic Receptor for Perylene Diimide with Picomolar Affinity in Water. J. Am. Chem. Soc. 2020, 142, 3165-3173.
67. Garci, A.; Weber, J. A.; Young, R. M.; Kazem-Rostami, M.; Ovalle, M.; Beldjoudi, Y.; Atilgan, A.; Bae, Y. J.; Liu, W.; Jones, L. O.; Stem, C. L.; Schatz, G. C.; Farha, O. K.; Wasielewski, M. R.; Stoddart, J. F. Mechanically Interlocked Pyrene-Based Photocatalysts. Nat. Catal. 2022, 5, 524-533.
68. Garci, A.; Beldjoudi, Y.; Kodaimati, M. S.; Hornick, J. E.; Nguyen, M. T.; Cetin, M. M.; Stern, C. L.; Roy, I.; Weiss, E. A.; Stoddart, J. F. Mechanical-Bond-Induced Exciplex Fluorescence in an Anthracene-Based Homo[2]catenane. J. Am. Chem. Soc. 2020, 142, 7956-7967.
69. Gong, X.; Zhou, J.; Hartlieb, K. J.; Miller, C.; Li, P.; Farha, O. K.; Hupp, J. T.; Young, R. M.; Wasielewski, M. R.; Stoddart, J. F. Toward a Charged Homo[2]catenane Employing Diazaperopyrenium Homophilic Recognition. J. Am. Chem. Soc. 2018, 140, 6540-6544.
70. Juríček, M.; Barnes, J. C.; Strutt, N. L.; Vermeulen, N. A.; Ghooray, K. C.; Dale, E. J.; McGonigal, P. R.; Blackburn, A. K.; Avestro, A.-J.; Stoddart, J. F. An ExBox[2]Catenane. Chem. Sci. 2014, 5, 2724-2731.
71. Chen, M.; Krzyaniak, M. D.; Nelson, J. N.; Bae, Y. J.; Harvey, S. M.; Schaller, R. D.; Young, R. M.; Wasielewski, M. R. Quintet-Triplet Mixing Determines the Fate of the Multiexciton State Produced by Singlet Fission in a Terrylenediimide Dimer at Room Temperature. Proc. Natd. Acad. Sci. U.S.A 2019, 116, 8178-8183.
72. Miyaura, N.; Suzuki, A. Palladium-Catalyzed Cross-Coupling Reactions of Organoboron Compounds. Chem. Rev. 1995, 95, 2457-2483.
73. The slip angles (θ) were calculated by the arcsine function according to their P-to-P and C-to-C distances. θ=arccos(P-to-P/C-to-C)
74. Lu, T.; Chen, Q. Independent Gradient Model Based on Hirshfeld Partition: A New Method for Visual Study of Interactions in Chemical Systems. J. Comput. Chem. 2022, 43, 539-555.
75. Barnes, J. C.; Juríček, M.; Strutt, N. L.; Frasconi, M.; Sampath, S.; Giesener, M. A.; McGrier, P. L.; Bruns, C. J.; Stem, C. L.; Sarjeant, A. A.; Stoddart, J. F. ExBox: A Polycyclic Aromatic Hydrocarbon Scavenger. J. Am. Chem. Soc. 2013, 135, 183-192.
76. Wu, Y.; Zhou, J.; Nelson, J. N.; Young, R. M.; Krzyaniak, M. D.; Wasielewski, M. R. Covalent Radical Pairs as Spin Qubits: Influence of Rapid Electron Motion between Two Equivalent Sites on Spin Coherence. J. Am. Chem. Soc. 2018, 140, 13011-13021.
77. Vauthey, E. Photoinduced Symmetry-Breaking Charge Separation. ChemPhysChem 2012, 13, 2001-2011.
78. Coleman, A. F.; Chen, M.; Zhou, J.; Shin, J. Y.; Wu, Y.; Young, R. M.; Wasielewski, M. R. Reversible Symmetry-Breaking Charge Separation in a Series of Perylenediimide Cyclophanes. J. Phys. Chem. C 2020, 124, 10408-10419.
79. Lippert, E. Spektroskopische Bestimmung des Dipolmomentes aromatischer Verbindungen im ersten angeregten Singulettzustand. Z. Elektrochem. 1957, 61, 962-975.
80. Szakics, Z.; Vauthey, E. Excited-State Symmetry Breaking and the Laporte Rule. J. Phys. Chem. Lett. 2021, 12, 4067-4071.
81. Wang, S.; Miao, Y.; Yan, X.; Ye, K.; Wang, Y. A Dibenzo[a,c]phenazine-11,12-dicarbonitrile (DBPzDCN) Acceptor Based Thermally Activated Delayed Fluorescent Compound for Efficient Near-Infrared Electroluminescent Devices. J. Mater. Chem. C 2018, 6, 6698-6704.
82. Wang, C.; Li, Z. Molecular Conformation and Packing: Their Critical Roles in the Emission Performance of Mechanochromic Fluorescence Materials. Mater. Chem. Front. 2017, 1, 2174-2194.
83. Wang, S.; Yan, X.; Cheng, Z.; Zhang, H.; Liu, Y.; Wang, Y. Highly Efficient Near-Infrared Delayed Fluorescence Organic Light Emitting Diodes Using a Phenanthrene-Based Charge-Transfer Compound. Angew. Chem. Int. Ed. 2015, 54, 13068-13072.
84. Englman, R.; Jortner, J. The Energy Gap Law for Radiationless Transitions in Large Molecules. Mol. Phys. 1970, 18, 145-164.
85. Wu, Y.; Zhou, J.; Phelan, B. T.; Mauck, C. M.; Stoddart, J. F.; Young, R. M.; Wasielewski, M. R. Probing Distance Dependent Charge-Transfer Character in Excimers of Extended Viologen Cyclophanes Using Femtosecond Vibrational Spectroscopy. J. Am. Chem. Soc. 2017, 139, 14265-14276.
86. Suseela, Y. V.; Das, S.; Pati, S. K.; Govindaraju, T. Imidazolyl-Naphthalenediimide-Based Threading Intercalators of DNA. ChemBioChem 2016, 17, 2162-2171.
87. Umeyama, T.; Igarashi, K.; Sasada, D.; Tamai, Y.; Ishida, K.; Koganezawa, T.; Ohtani, S.; Tanaka, K.; Ohkita, H.; Imahori, H. Efficient Light-Harvesting, Energy Migration, and Charge Transfer by Nanographene-Based Nonfullerene Small-Molecule Acceptors Exhibiting Unusually Long Excited-State Lifetime in the Film State. Chem. Sci. 2020, 11, 3250-3257.
88. Eastham, N. D.; Logsdon, J. L.; Manley, E. F.; Aldrich, T. J.; Leonardi, M. J.; Wang, G.; Powers-Riggs, N. E.; Young, R. M.; Chen, L. X.; Wasielewski, M. R.; Melkonyan, F. S.; Chang, R. P. H.; Marks, T. J. Hole-Transfer Dependence on Blend Morphology and Energy Level Alignment in Polymer: ITIC Photovoltaic Materials. Adv. Mater. 2018, 30, 1704263.
89. Saladina, M.; Simón Marqués, P.; Markina, A.; Karuthedath, S.; Wöpke, C.; Göhler, C.; Chen, Y.; Allain, M.; Blanchard, P.; Cabanetos, C.; Andrienko, D.; Laquai, F.; Gorenflot, J.; Deibel, C. Charge Photogeneration in Non-Fullerene Organic Solar Cells: Influence of Excess Energy and Electrostatic Interactions. Adv. Funct. Mater. 2021, 31, 2007479.
90. Ramirez, C. E.; Chen, S.; Powers-Riggs, N. E.; Schlesinger, I.; Young, R. M.; Wasielewski, M. R., Symmetry-Breaking Charge Separation in the Solid State: Tetra(phenoxy)perylenediimide Polycrystalline Films. J. Am. Chem. Soc. 2020, 142, 18243-18250.
91. Shen, K.; Qin, L.; Zheng, H.-G. Diverse Structures of Metal-Organic Frameworks via a Side Chain Adjustment: Interpenetration and Gas Adsorption Dalton Trans. 2016, 45, 16205-16210
92. Dolomanov, O. V.; Bourhis, L. J.; Gildea, R. J.; Howard, J. A.; Puschmann, H. OLEX2: A Complete Structure Solution, Refinement and Analysis Program. J. Appl. Cryst. 2009, 42, 339-341.
93. Sheldrick, G. SHELXT-Integrated Space-Group and Crystal-Structure Determination. Acta Cryst. 2015, 71, 3-8.
94. Sheldrick, G. A Short History of SHELX. Acta Cryst. 2008, 64, 112-122
95. Gunderson, V. L.; Smeigh, A. L.; Kim, C. H.; Co, D. T.; Wasielewski, M. R. Electron Transfer within Self-Assembling Cyclic Tetramers Using Chlorophyll-Based Donor-Acceptor Building Blocks. J. Am. Chem. Soc. 2012, 134, 4363-4372.
96. Eaton, S. W.; Shoer, L. E.; Karlen, S. D.; Dyar, S. M.; Margulies, E. A.; Veldkamp, B. S.; Ramanan, C.; Hartzler, D. A.; Savikhin, S.; Marks, T. J.; Wasielewski, M. R. Singlet Exciton Fission in Polycrystalline Thin Films of a Slip-Stacked Perylenediimide. J. Am. Chem. Soc. 2013, 135, 14701-14712.
97. Wu Y.; Mohan Nalluri, S. K.; Young, R. M.; Krzyaniak, M. D.; Margulies, E. A.; Stoddart, J. F.; Wasielewski, M. R. Charge and Spin Transport in an Organic Molecular Square. Angew. Chem. Int. Ed. 2015, 54, 11971-11977.
98. Austin, A.; Petersson, G. A.; Frisch, M. J.; Dobek, F. J.; Scalmani, G.; Throssell, K. A Density Functional with Spherical Atom Dispersion Terms. J. Chem. Theory Comput. 2012, 8, 4989-5007.
99. Lu, T.; Chen, Q. Independent Gradient Model Based on Hirshfeld Partition: A New Method for Visual Study of Interactions in Chemical Systems. J. Comput. Chem. 2022, 43, 539-555
100. Lu, T.; Chen, F. Multiwfn: A Multifunctional Wavefunction Analyzer. J. Comput. Chem. 2012, 33, 580-592.
101. Humphrey, W.; Dalke, A.; Schulten, K. VMD: Visual Molecular Dynamics. J. Mol. Graph. 1996, 14, 33-38.

1. A method for live cell imaging, the method comprising irradiating a cell in contact with a composition for live cell imaging and detecting an emission signal, wherein the composition for live cell imaging comprises a cyclophane having an alternating cyclic arrangement of two quadrupolar subunits and two bridging subunits, wherein the quadrupolar subunit has a formula of 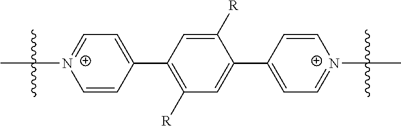
and wherein R is an electron-donating group (EDG).

2. The method of claim 1, wherein the composition for live cell imaging comprises between 1-50 μM of the cyclophane.

3. The method of claim 1, wherein the composition for live cell imaging comprises between 1-10 μM of the cyclophane.

4. The method of claim 1, wherein R is an alkoxy.

5. The method of claim 4, wherein R is methoxy.

6. The method of claim 1, wherein the bridging subunit comprises a para-xylylene linker of formula

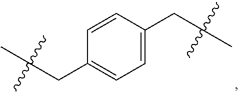 [SMILES: *Cc1ccc(C*)cc1]

7. The method of claim 1, wherein the cyclophane has a formula of 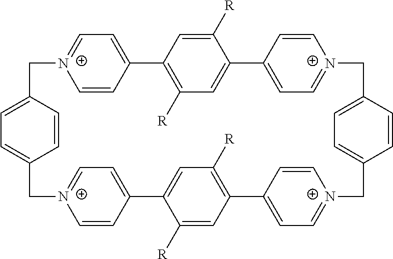
wherein R is an alkoxy.

8. The method of claim 1, wherein the cyclophane has a formula of

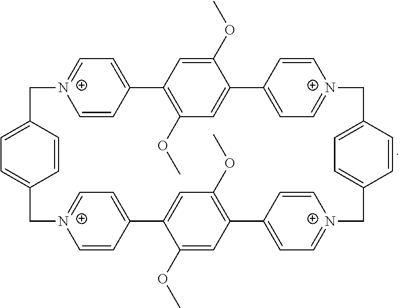 [SMILES: COc1cc2c(OC)cc1-c1cc[n+](cc1)Cc1ccc(cc1)C[n+]1ccc(cc1)-c1cc(OC)c(cc1OC)-c1cc[n+](cc1)Cc1ccc(cc1)C[n+]1ccc-2cc1]

9. The method of claim 1, wherein detecting the emission signal comprises detecting radiation emitted from the cyclophane internalized within the cell.

10. The method of claim 1, wherein the cell is contacted with the composition for live cell imaging for a period of time prior to irradiating the cell.

11. The method of claim 1, wherein the emission signal is in the visible spectrum.

12. The method of claim 1, wherein the cell is irradiated with visible or near-UV radiation.

13. The method of claim 1, wherein the cells are cancer cells.

14. A composition for live cell imaging comprising the cyclophane according to claim 1, wherein the composition for live cell imaging emits a detectible signal when the composition for live cell imaging comprises between 1-10 μM of the cyclophane.

15. The composition of claim 14, wherein the composition for live cell imaging is non-cytotoxic.

16. The composition of claim 14, wherein R is an alkoxy.

17. The composition of claim 16, wherein R is methoxy.

18. The composition of claim 14, wherein the bridging subunit comprises a para-xylylene linker of formula

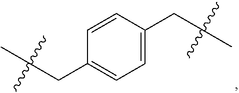 [SMILES: *Cc1ccc(C*)cc1]

19. The composition of claim 14, wherein the cyclophane has a formula of 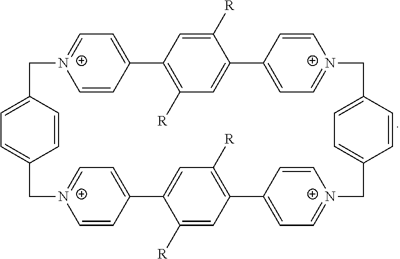
wherein R is an alkoxy.

20. The composition of claim 14, wherein the cyclophane has a formula of

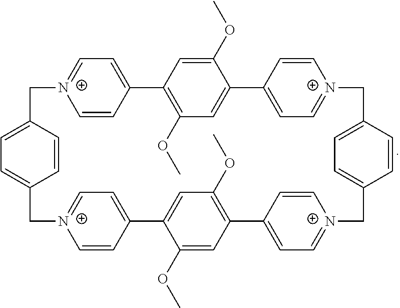 [SMILES: COc1cc2c(OC)cc1-c1cc[n+](cc1)Cc1ccc(cc1)C[n+]1ccc(cc1)-c1cc(OC)c(cc1OC)-c1cc[n+](cc1)Cc1ccc(cc1)C[n+]1ccc-2cc1]

21. The composition of claim 14 wherein the composition for live cell imaging further comprises a counter anion.

22. The composition of claim 14, wherein the composition for live cell imaging further comprises a non-cytotoxic carrier.

23. A kit for live cell imaging comprising a first container containing the composition for live cell imaging according to claim 14 and a second container containing a cell.
